(19) United States
(12) Patent Application Publication
(10) Pub. No.: US 2025/0104500 A1
(43) Pub. Date: Mar. 27, 2025

(54) TRANSPARENT, VERIFIABLE, MUTUALLY RESTRAINING ELECTRONIC VOTING

(71) Applicant: The Trustees of Indiana University, Bloomington, IN (US)

(72) Inventors: Xukai Zou, Carmel, IN (US); Nathan Swearingen, Zionsville, IN (US)

(21) Appl. No.: 18/811,009

(22) Filed: Aug. 21, 2024

Related U.S. Application Data
(60) Provisional application No. 63/585,087, filed on Sep. 25, 2023.

(51) Int. Cl. G07C 13/00

(52) U.S. Cl. CPC G07C 13/00; G06Q 2230/00

(57) ABSTRACT

An electronic voting system includes voter devices, used by voters to select and commit their respective choices from among different options in an election, and ballot collection servers. Each of the voter devices computes a secrecy-maintaining ballot that is publishable without revealing the choice made by the voter. The voter's choice is obscured in the public ballot by summing the voter's vote, a binary vector, with voter shares contributed from each of the ballot collection servers. Aggregating the ballots provides a tallied voting vector that unobscures the votes and permits their tallying without revealing the identity of any voter associated with any choice in the tallied voting vector. The unique location of any voter's choice in the tallied voting vector is secret to each voter as a sum of location shares generated jointly generated by the ballot collection servers using secure multi-party computation.

### CROSS-REFERENCE TO RELATED APPLICATIONS

This application claims the benefit of U.S. Provisional Patent Application No. 63/585,087, filed on Sep. 25, 2023, the disclosure of which is incorporated herein by reference in its entirety.

### STATEMENT OF FEDERALLY SPONSORED RESEARCH OR DEVELOPMENT

This invention was made with government support under 4894141 awarded by National Science Foundation. The Government has certain rights in the invention.

### TECHNICAL FIELD

This description relates generally to electronic voting, and more particularly to transparent, verifiable, mutually restraining electronic voting.

### BACKGROUND

Secure, verifiable voting is a pillar of modern democracy and business governance. Electronic voting offers advantages, including convenience and cost-reduction, over conventional in-person paper ballot voting. As just a few examples, electronic voting can be implemented remotely, so that voters can vote from devices, such as personal computers or smartphones, that need not be located within a particular polling venue. Thus, for example, voters can vote from the comfort of their homes or workplaces, without risk of work absence or personal contact exposure with other voters or poll workers, as may be a consideration during a pandemic. Electronic voting can be practicably implemented over any voting time window, allowing voters to vote outside of the daytime hours that traditional polling places might be limited to staying open. Electronic voting can obviate the need for secure ballot drop boxes and/or postage needed to submit mail-in ballots. The lack of a requirement to print and preserve physical ballots can save printing, storage, transportation, and security costs, and can allow last-minute ballot changes to be implemented with minimal cost and confusion. By eliminating or reducing the need for polling venues, electronic voting can eliminate or reduce the need for associated logistical considerations such as the training and payment of poll workers and voter education initiatives needed to alert voters to the geographic locations of their respective proper polling venues, thus also reducing costs of holding an election. Electronic voting can simplify and speed vote tallying, allowing for election results to be announced sooner and with greater confidence as compared to traditional paper ballot tallying methods.

In the context of this description, “secret sharing” refers to methods for distributing a secret among a group of computing devices as individual “shares” each held by individual ones of the computing devices, in such a way that no individual one of the computing devices holds intelligible information about the secret, but when a sufficient number of the individual computing devices, such as all of the computing devices, combine their respective shares, the secret can be reconstructed. Secure multi-party computation (SMPC) refers to one or more cryptography methods permitting separate individual computing devices to jointly compute a function over their respective inputs while keeping the inputs belonging to the individual computing devices private to the inputs' respective individual computing devices. The cryptography in SMPC thus protects the computing devices' privacy from each other. Secure multi-party multiplication (SMPM) and secure two-party multiplication (STPM) are examples of SMPC.

### SUMMARY

An example electronic voting system includes at least three voter devices, each including a computer processor, and at least two ballot collection servers, each including a computer processor. Each of the ballot collection servers is configured to generate, by communicably connecting to each other of the ballot collection servers and using secure multi-party computation (SMPC), at least one location share for each of the voter devices. The location shares are generated so that a sum of the location shares for any one of the voter devices from each of the ballot collection servers represents a unique ballot number for a corresponding voter associated with the one of the voter devices. The unique ballot number is known by no individual one of the ballot collection servers. Each of the ballot collection servers is further configured to generate, for each of the voter devices, at least two voter shares as random or pseudo-random values. Each of the ballot collection servers is further configured to commit its location shares and its voter shares using a commitment protocol of the respective ballot collection server. Each of ballot collection servers is further configured to transmit, to each of the voter devices, the at least one location share and the at least two voter shares generated by the respective one of the ballot collection servers for the respective one of the voter devices. Each of the voter devices is configured to receive from a corresponding voter a selection, as a choice of the corresponding voter, of one option from among a plurality of options in an election. The selection is made via a user input of the voter device. Each of voter devices is further configured to commit the corresponding voter's choice using a commitment protocol of the respective voter device. Each of the voter devices is further configured to compute a respective ballot based on the respective committed choice of the respective one of the voter devices, the location shares received by the respective one of the voter devices from the ballot collection servers, and the voter shares received by the respective one of the voter devices from the ballot collection servers. Each of the voter devices is further configured to transmit the respective ballot via a communication interface of the voter device.

An example electronic voting method includes each of a plurality of ballot collection servers generating, by communicably connecting to each other of the plurality of ballot collection servers and using secure multi-party computation (SMPC), at least one location share for each of a plurality of voter devices. The location shares are generated so that a sum of the location shares for any one of the plurality of voter devices from each of the ballot collection servers represents a unique ballot number for a corresponding voter associated with the one of the plurality of voter devices. The unique ballot number is known by no individual one of the plurality of ballot collection servers. Each of the plurality of ballot collection servers generate, for each of the plurality of voter devices, at least two voter shares as random or pseudo-random values. Each of the plurality of ballot collection servers commits its location shares and its voter shares using a commitment protocol of the respective one of the plurality of ballot collection servers. Each of the plurality of ballot collection servers transmit, to each of the plurality of voter devices, the at least one location share and the at least two voter shares generated by the respective one of the plurality of ballot collection servers for the respective one of the plurality of voter devices. Each of a number of the plurality of voter devices receive, from a corresponding voter, a selection, as a choice of the corresponding voter, of one option from among a plurality of options in an election, the selection made via a user input of the respective one of the plurality of voter devices. Each of the number of the plurality of voter devices commits the corresponding voter's choice using a commitment protocol of the respective one of the plurality of voter devices. Each of the number of the plurality of voter devices computes a respective ballot based on (a) the respective committed choice of the respective one of the plurality of voter devices, (b) the location shares received by the respective one of the plurality of voter devices from the plurality of ballot collection servers, and (c) the voter shares received by the respective one of the plurality of voter devices from the plurality of ballot collection servers. Each of the number of the plurality of voter devices transmits the respective ballot via a communication interface of the respective one of the plurality of voter devices.

An example includes one or more non-transitory computer-readable media storing program instructions that, when executed by one or more processors in a ballot collection server, cause the one or more processors to do the following. The one or more processors communicably connect the ballot collection server to each of a plurality of other ballot collection servers and use secure multi-party computation (SMPC) to generate at least one location share for each of a plurality of voter devices. The location shares are generated so that a sum of the location shares generated by the ballot collection server and the plurality of other ballot collection servers for any one of the plurality of voter devices represents a unique ballot number for a corresponding voter associated with the one of the plurality of voter devices. The unique ballot number is known by no individual one of the plurality of other ballot collection servers or by the ballot collection server. The one or more processors generate, for each of the plurality of voter devices, at least two voter shares as random or pseudo-random values. The one or more processors commit each of the location shares and each of the voter shares generated by the ballot collection server using a commitment protocol. The one or more processors transmit, to each of the plurality of voter devices, the at least one location share and the at least two voter shares generated by ballot collection server for the respective one of the plurality of voter devices. The one or more processors receive a plurality of ballots each generated and transmitted by a respective one of the voter devices. Each of the plurality of ballots is generated based on (a) a single commitment-protocol committed election choice of a voter associated with the respective one of the plurality of voter devices, (b) the at least one location share transmitted to the respective one of the plurality of voter devices from the ballot collection server, (c) other location shares transmitted to the respective one of the plurality of voter devices from the plurality of other ballot collection servers, (d) at least one of the at least two voter shares transmitted to the respective one of the plurality of voter devices from the ballot collection server, and (e) other voter shares transmitted to the respective one of the plurality of voter devices from the plurality of other ballot collection servers.

An example includes one or more non-transitory computer-readable media storing program instructions that, when executed by one or more processors in a voter device, cause the one or more processors to do the following. The one or more processors receive from a voter a selection, as a choice of the voter, of one option from among a plurality of options in an election, the selection made via a user input of the voter device. The one or more processors commit the voter's choice using a commitment protocol. The one or more processors connect the voter device to a plurality of ballot collection servers to receive at least one location share and at least two voter shares from each of the plurality of ballot collection servers, each of the location shares generated by one of the plurality of ballot collection servers in communication with each other and using secure multi-party computation (SMPC). Pairs of the voter shares are each generated by one of the plurality of ballot collection servers as random or pseudo-random values. The one or more processors compute a unique ballot number, representative of a location in a voting vector, as a sum of the location shares. The one or more processors compute a ballot based on (a) the voter's choice, (b) the unique ballot number, and (c) a sum of a first of each pair of the voter shares from each of the plurality of ballot collection servers. The one or more processors transmit the respective ballot via a communication interface of the voter device.

### BRIEF DESCRIPTION OF THE DRAWINGS

FIG. 1 is a block diagram of an example electronic voting system.

FIGS. 2A through 2F are connection diagrams of components of an example electronic voting system illustrating their interactions at various stages of an election procedure.

FIGS. 3A through 3C are connection diagrams of components of an example electronic voting system illustrating their interactions at various stages of an election procedure.

FIG. 4 is a diagram illustrating the contributions of the votes of various voter devices of an electronic voting system to a tallied voting vector in an example election having two vying choices.

FIG. 5 is a diagram illustrating the contributions of the votes of four different voter devices of an electronic voting system to individual voting vectors and to a tallied voting vector in an example election having two vying choices.

FIGS. 6A and 6B are flow diagrams illustrating an example method of conducting an election using an electronic voting system.

### DETAILED DESCRIPTION

Electronic voting systems, computer-implemented methods, and non-transitory computer-readable media described herein permit fully transparent, verifiable, and mutually restraining electronic voting, providing for fair elections without a central trusted tallying authority. The electronic voting systems, computer-implemented methods, and non-transitory computer-readable media described herein address the need for a voting platform that is practical, resilient, accessible, and can be employed for casting ballots and tallying and verifying votes cast in-person or remotely, in the latter case without the health or safety risks that can be associated with personal attendance and/or queuing at a polling venue. The electronic voting systems, computer-implemented methods, and non-transitory computer-readable media described herein allow any voter to verify the voter's individual vote(s), and for anyone to tally and verify vote counts.

Using the electronic voting systems, computer-implemented methods, and non-transitory computer-readable media described herein, the entire process of ballot casting, tallying, and verification can be made transparent to anyone without sacrificing the privacy of secret balloting. The described systems and methods are resistant to the misbehavior of any participant and to outside attacks. Such resistance, verifiability, and transparency mean that invalid votes and attacks can be detected with high probability. The described systems and methods can be used for any kind of elections, including corporate proxy voting of stock shares; municipal, county, parish, state, federal, or national governmental elections; club, organization, institution, or jury voting; or any kind of election where the convenience or electronic voting and/or secret balloting may be desired. The described systems and methods can be used to vote for officers, issues, or any other type of preference. The described systems and methods can be configured to work for single-choice, ranked-choice (instant-runoff), and approval voting.

As used in this description, “option” means one of several input possibilities in a list of such possibilities up for election. As examples, the term “option” can thus refer to an option of a preferred candidate for office, an option of an outcome preference in relation to an issue to be decided, or an option that encodes a particular ranking of preferred candidate or issue outcome options (in a ranked-voting election) or encodes a particular list of one or more preferred candidate or issue outcome options that have the approval of the voter (in an approval voting election). As used herein, the term “choice” refers to a singularly selected option, from among a set of such options in an election, to which a voter commits using a commitment protocol such as Pedersen commitment. Thus, in the context of the present description, it is expected that a voter acting with proper conduct may make only one choice (may commit to only one selected option) when voting, even if the choice may encode for a plurality of candidates or issues, and that, in the context of this description, selection of more than one choice may constitute impermissible voter misconduct or ballot manipulation that is discoverable by the systems or methods of the present description. The term “election” as used herein refers to a process of casting and tallying ballots from a plurality of voters with regard to a single set of mutually exclusive options vying against each other. A “voting session” can comprise multiple elections conducted contemporaneously, for example, when it is desired to elect, in a single voting timeframe, candidates for different offices or issues. Thus, in the context of a single election, as that term is used herein, each voter may select only one choice, as that term is used herein. These definitions do not preclude an election using ranked-choice voting or approval voting, for example, by encoding combinations of plural candidates or issue options as individual voter-selectable choices. A “voter” can be a human participant in an election, an organizational participant, a machine intelligence, or any other entity capable of making a choice from among a finite plurality of options.

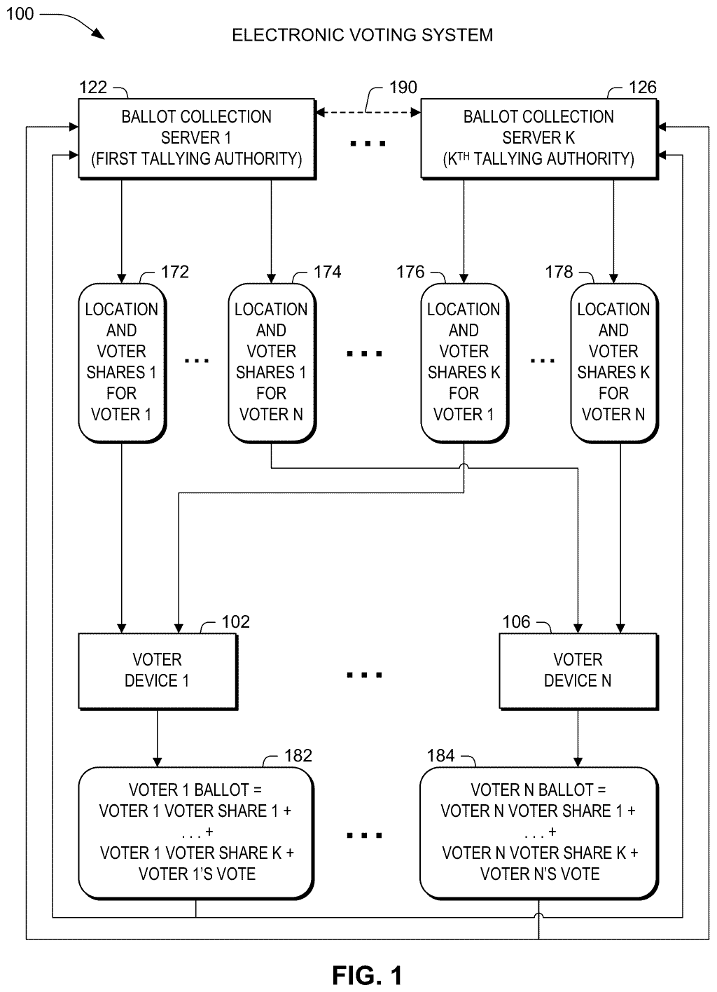

FIG. 1 illustrates an example electronic voting system 100. The electronic voting system 100 includes a number N, three or greater, of voter devices used by voters to cast their ballots and a number K, two or greater, of ballot collection servers used by tallying authorities to collect ballots and tally ballots to determine election results. In the illustrated example, the voter devices are represented by a first voter device 102 and an Nth voter device 106. In the illustrated example, the ballot collection servers are represented by a first ballot collection server 122 and a Kth ballot collection server 126.

Each of the voter devices and ballot collection servers can include general-purpose computing devices or special-purpose computing devices, for example, special-purpose computing devices restricted to performing their respective particular functions within the electronic voting system. Each of the voter devices includes a communication-enabled computing device that includes a general-purpose or special-purpose processor configured at least to permit a voter to select one option from among a finite plurality of options in an election; to commit the voter's choice using a commitment protocol, such as Pedersen commitment; to compute a ballot based on the committed choice and based on location shares and voter shares received from the ballot collection servers; and to transmit the computed ballot via a communication interface, such as a network interface, of the voter device. The voter devices can each include or be coupled to one or more user input devices, one or more user output devices (such as display devices), or some combination thereof, such as touchscreens, for registering voter choices. The one or more user input devices can include, as examples, a keyboard, a keypad, a touchpad or other touch-sensitive input, a microphone, a mouse, a trackball, a motion sensor, or any other user input device known in the art. The one or more user output devices can include, as examples, a video screen, a speaker, a projector, a haptic device, a Braille output device, or any other user output device known in the art. As examples, the voter devices can be personal computers, such as desktop or laptop computers; mobile devices, such as smartphones or tablets; or can be devices placed in or integrated into polling booths at physical polling venues.

The voter devices can, in some examples, log in and cast ballots via a website, a dedicated application (“app”), or any other method by which an authorized registered voter can be authenticated. Voter authentication can use passwords, public/private keys, passkeys, multi-factor authentication, biometric authentication (such as fingerprint-based or facial-recognition-based authentication), continuous authentication, or any kind of authentication desired to meet the security standards of the election. In some examples, the voter devices are located remotely from the ballot collection servers to enable remote voting. In such examples, the voter devices can be in the custody and control of respective individual voters, without compromising the security and verifiability of the electronic voting system 100. In other examples, one or more of the voter devices are collocated with each other and/or with one or more of the ballot collection servers, for example, allowing an election authority to maintain custody and control over the voter devices.

Each of the ballot collection servers includes a communication-enabled computing device that includes a general-purpose or special-purpose processor configured at least to communicatively connect to the other ballot collection servers to generate, for each of the voter devices, a location share using secure multi-party computation (SMPC); to generate, for each of the voter devices, voter shares as random or pseudo-random values; to commit the location shares and voter shares using a commitment protocol, such as Pedersen commitment; to transmit the shares to respective voter devices; to receive ballots computed by respective voter devices; and to publish the ballots and/or tally the ballots and publish the tallies. The ballot collection servers can be configured as servers connected to a network, such as an intranet or the internet. The ballot collection servers can, in some examples, be implemented using virtual machines and/or containers, for example, in a cloud computing architecture. In some examples, the ballot collection servers are each separately in the custody and control of human or organizational operators that are adverse to each other, that is, by operators having conflicted interests, such as by adverse political parties fielding different candidates in an election. Thus, for example, first ballot collection server 122 may be in the custody and control of a first political party (“Blue Party”) and Kth ballot collection server may be in the custody and control of a Kth political party (“Red Party”), which is adverse to the first political party in the context of the election being carried out in full or in part by electronic voting system 100. The ballot collection servers are thus assumed not to be in collusion with one another, and communicate and collaborate with each other without divulging their respective secret shares to each other. The ballot collection servers can be securely coupled to each other, and the individual voter devices can be coupled to the ballot collection servers, persistently or non-persistently, via direct wired or wireless connections, an intranet, or the internet. As described in greater detail below, the voter devices and ballot collection servers can carry out other functions in addition to casting ballots and receiving and tallying ballots. In some examples, there are as many ballot collection servers K as there are options in the election, but in other examples, there are more or fewer ballot collection servers.

The ballot collection servers obtain information about registered voters, for example, from one or more election administration servers (not shown in FIG. 1), and the voter devices connect to the ballot collection servers to cast ballots. Before or upon this connection, each ballot collection server cryptographically generates, for each of the voters, values referred to herein as location shares and voter shares, and transmits the generated location shares and voter shares to each of the voter devices. This transfer is depicted in the illustrated example as first ballot collection server 122 transferring location and voter shares 172 to first voter device 102 and transferring location and voter shares 174 to Nth voter device 106, and as Kth ballot collection server 126 transferring location and voter shares 176 to first voter device 102 and transferring location and voter shares 178 to Nth voter device 106. For example, each ballot collection server generates as many sets of location and voter shares as there are registered voters, that is, N sets of location and voter shares. For example, each voter device receives as many sets of location and voter shares as there are ballot collection servers 122. In some examples, each set of location and voter shares includes three numbers: one location share r_{k,i} and two voter shares x_{k,i}, x′_{k,i}, where k is the number of the ballot collection server (a number between 1 and K, inclusive) and i is the number of the voter (a number between 1 and N, inclusive). The cryptographic generation of the location shares can include collaboration among the ballot collection servers using secure multi-party computation (SMPC), such as secure multi-party multiplication (SMPM), as described in greater detail below. For example, SMPC can be employed to guarantee that, for each voter Vᵢ, the sum of the location shares r_{l,i}+ . . . +r_{K,i} is a number that is unique to the voter Vᵢ. The ballot collection servers can connect to each other via one or more connections 190 for the purposes of carrying out cryptographic collaboration to generate the shares. The ballot collection servers can compute the voter shares as random or pseudo-random values that all fall within a range related to the length L of a voting vector, and which have the constraints that the voter shares x_{k,i} across all voters and generated by any single ballot collection server sum to zero, and, similarly, that the voter shares x′_{k,i}, across all voters and generated by any single ballot collection server, also sum to zero.

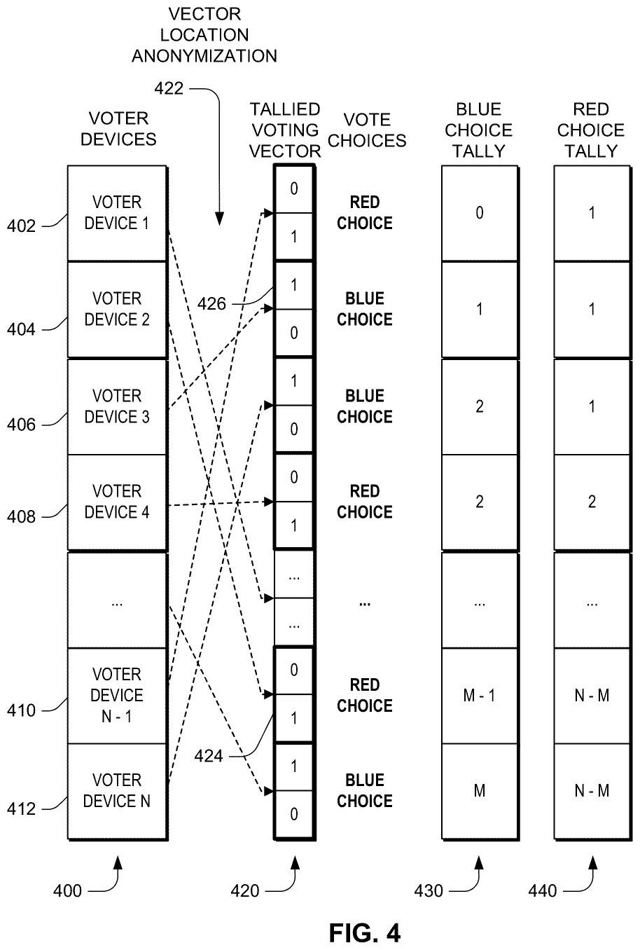

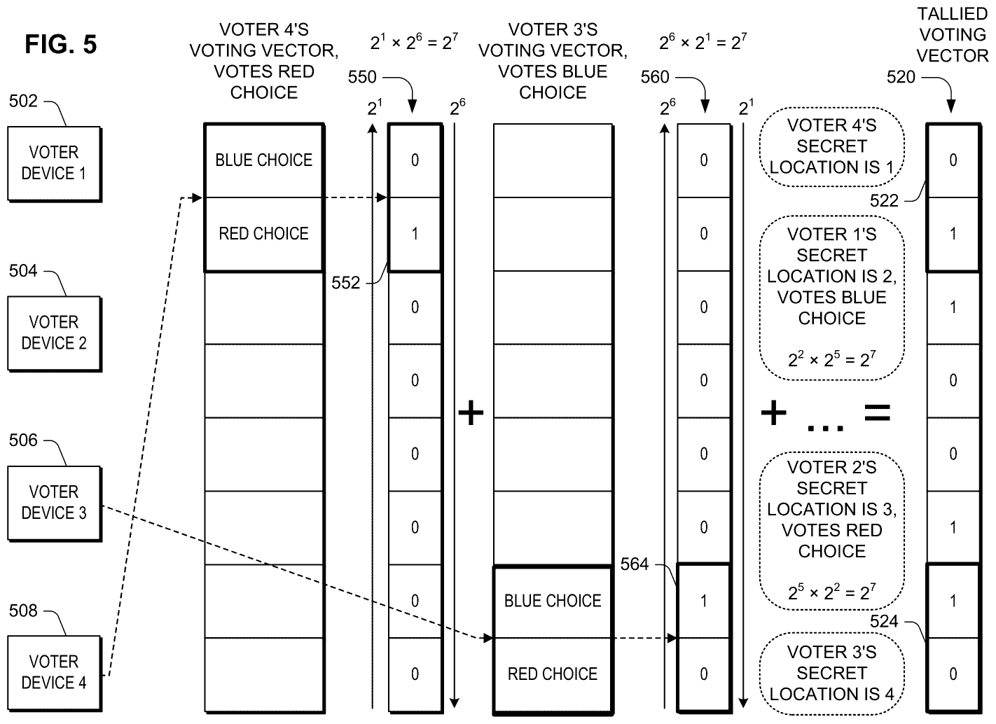

Each voter device independently computes a vote based on (a) the K location shares received by the voter device from the ballot collection servers, which together determine a ballot number. The ballot number is a unique “secret location” in a binary voting vector of length L bits, zero-padded to the most significant bit, where L is the product of the number of voters N and the number of options in the election, and (b) a choice selected by a voter, which is committed using a commitment protocol. Each vote thus encodes both the voter's choice and the voter's ballot number (unique secret location). The secret location is secret in that it is known only to the respective individual voter device (and thus only to the voter using the voter device, absent any disclosure of the secret location by the voter), and not to any of the ballot collection servers, any of the other voters, or any other devices within system 100. For example, the ballot number (unique secret location) lᵢ for the ith voter Vᵢ can be computed as the sum of all the location shares received by the voter device from the ballot collection servers: lᵢ=r_{l,I}+ . . . +r_{K,i}. Although the voter device generates the secret location, it should be appreciated that the unique secret location is not determined in any part by the voter or voter device. That is, neither the voter device nor the voter have a role in deciding what the voter's ballot number (unique secret location) will be. This is because the secret location is generated based solely on the location shares received from the ballot collection servers. A single voter's vote vᵢ can thus be represented as a binary voting vector of length L bits (zero-padded to the most significant bit) with only one of the bits asserted. In some examples, an asserted bit is a logical “1” and all other (unasserted) bits are logical “0” (“one-hot”), but in other examples, an asserted bit can be a logical “0” with all other (unasserted) bits being logical “1” (“one-cold”). The voter device can also compute the bit-reversed vote v′ᵢ, which is a binary vector that is the bit-reversal permutation of the vote vᵢ (also zero-padded to the most significant bit). For example, if a vote vᵢ is “00000010” (2¹) in an election of N=4 voters and two options, the bit-reversed vote v′ᵢ is “01000000” (2⁶). The binary voting vectors are discussed in greater detail below with regard to FIGS. 4 and 5.

Having computed a vote vᵢ and a bit-reversed vote v′ᵢ, each voter device can then independently compute a respective ballot for the voter Vᵢ based on (a) the computed vote and (b) the voter shares received by the voter from the ballot collection servers. For example, the voter device for voter Vᵢ can compute a ballot (pᵢ, p′ᵢ) as pᵢ=vᵢ+x_{1,i}+ . . . +x_{K,i} and p′ᵢ=v′ᵢ+x′_{1,i}+ . . . +x′_{K,i}.

Each voter device can connect to each ballot collection server to transmit the computed ballots to all the ballot collection servers. In the example illustrated in FIG. 1, the first voter device 102 transmits its respective generated ballot 182 to the first ballot collection server 122, to the Kth ballot collection server 126, and to every other ballot collection server in system 100, and the Nth voter device 106 transmits its respective generated ballot 184 to the first ballot collection server 122, to the Kth ballot collection server 126, and to every other ballot collection server in system 100. The ballot collection servers can work together, communicating via connection(s) 190, to jointly verify the validity of each ballot received. The collection servers can ensure that only one ballot is received from each voter for any one election, and that each ballot (and thus each voter) votes for only one choice in each ballot (and thus in each election). The collection servers can compute tallies as ballots are received from voters and can publish their tallies without risk of exposing the secrecy of any ballot from any single voter, that is, without making public the correspondence between a choice and the identity of that choice's respective voter.

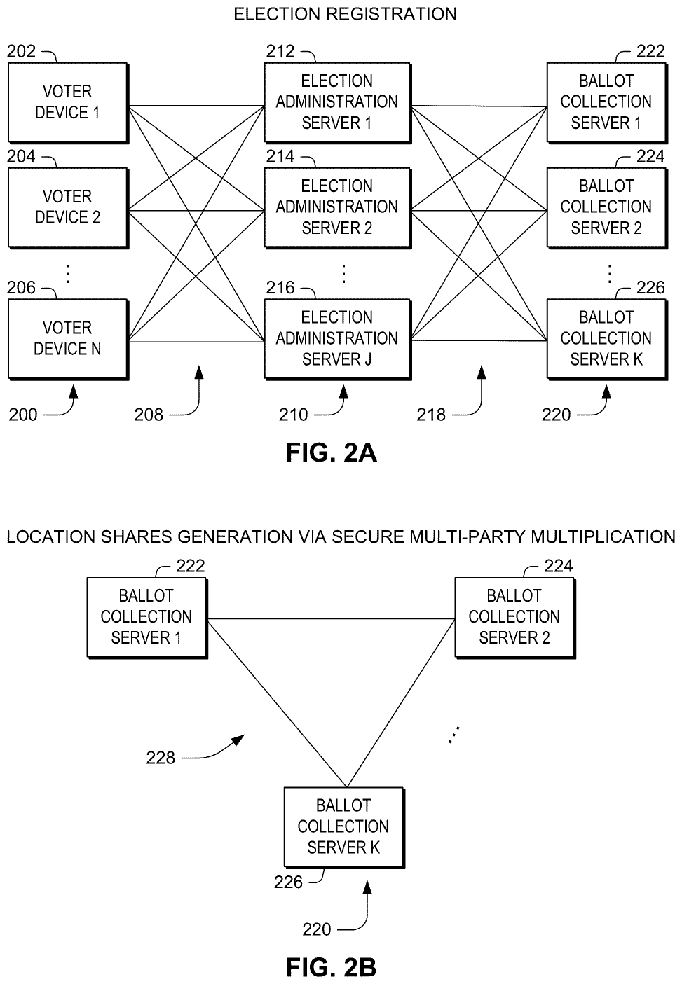

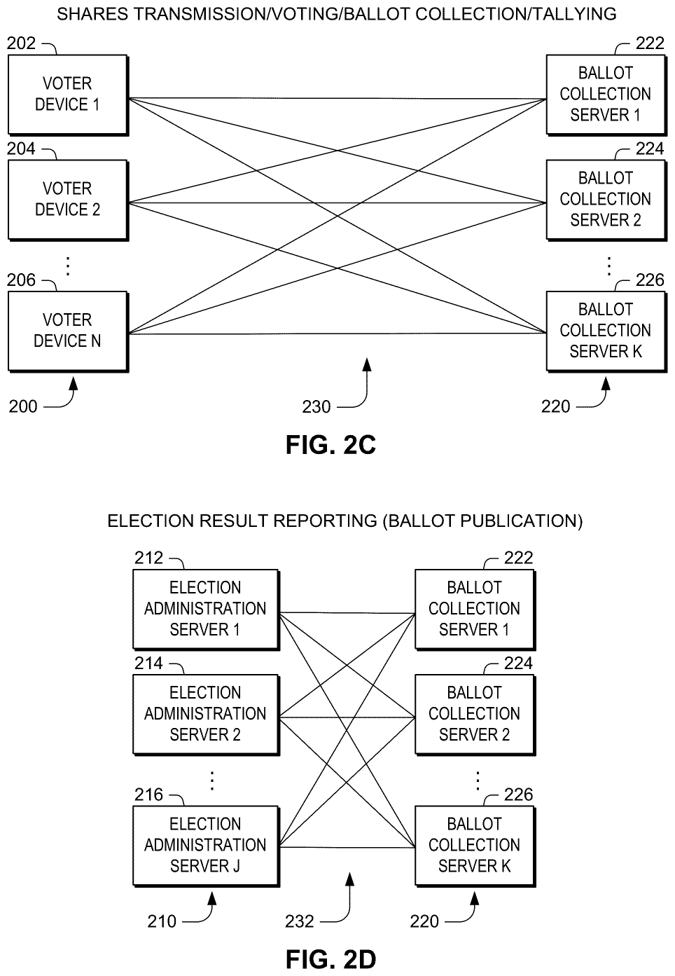

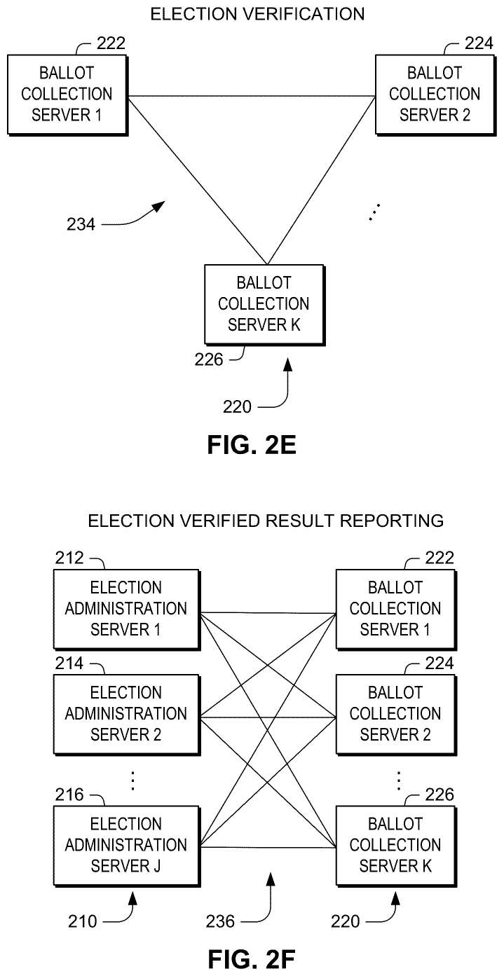

FIGS. 2A through 2F illustrate an example election procedure in accordance with the electronic voting systems and methods described herein. FIG. 2A illustrates a configuration of N voter devices 200, J election administration servers 210, and K ballot collection servers 220 during an election registration phase. In the illustrated example, N is any number three or greater, K is any number two or greater, and J is any number one or greater. FIG. 2A illustrates more than one election administration server 210, but in other examples, a single election administration server 212 can be used. Use of multiple redundant election administration servers 210 can have the advantage of proofing the system's resilience against power failures or computer system outages affecting any one election administration server or fewer than all of the election administration servers 210. By contrast, the different ballot collection servers 220 are not redundant with each other, and each one plays a distinct and critical role in the election system. Each ballot collection server 220 can have one or more mirrored counterparts for redundancy, but such counterparts are not illustrated in FIGS. 2A-2F.

An election is set up by an election administrator on the one or more election administration severs 210. The setup of the election can include the establishment of the choices, such as candidates for office or issue options, for the election, and the voter rolls for the election. The setup can also include providing a deadline for registration and a timeframe (window) for voting defined by an election start time and an election end time. The voter rolls can include identifying information for each of the voters in a pool of voters that are eligible to register for the election and subsequently participate in the election. During the election registration phase illustrated in FIG. 2A, voter devices 200 each connect 208 to one or more election administration servers 210 to register for the election or voting session. In some examples, a voter who has registered for an election or voting session previously administered using the electronic voting system need not register again for an upcoming election or voting session. In other examples, all voters can be required by the election administration servers 212 to re-register for each new election or each new voting session.

In some examples, the voter devices 200 need only connect 208 to one election administration server 212, and not multiple election administration servers 210, to complete registration, and the resultant registration information can be automatically mirrored to other election administration servers 214 through 216. In some examples, should a primary election administration server 212 be down, connections 208 for registration by voter devices 200 can be automatically routed to a secondary election administration server 214 or another election administration server 216. The one or more election administration servers 210 can store authentication information for the voters, such as login information (usernames, passwords, biometric information, etc.) or information used for continuous authentication, permitting a voter to later login to the electronic voting system to vote using a different voter device than the one used to register for the election. The one or more election administration servers 210 can also store information for identifying and authenticating the ballot collection servers 220. In some examples, each of the ballot collection servers 220 can register with the one or more election administration servers 210 via connections 218.

The ballot collection servers 220, properly registered and authenticated, can connect via connections 218 to the one or more election administration servers 210 to receive information about the election and registered voters. For example, the ballot collection servers 220 can retrieve information about the options in the election and voter information needed to receive ballots from voters and ensure that they are from properly registered and authenticated voters via authorized voter devices 200 in a subsequent phase of the election.

At the time of the registration deadline or prior to the start of an election timeframe (voting window), registration is closed, no further registrations from voter devices are accepted, and the length L of a binary voting vector for the election is definitively established as the product of the number of options in the election and the number of voters N (in bits). Binary voting vectors are discussed in greater detail below with regard to FIGS. 4 and 5. In some examples, a number of dummy voter registrations can be created to accommodate permitted late registrants or registrants in systems that permit for “same-day” or “at time of voting” voter registration. The dummy registrations can be assigned to permitted late registrants or permitted at-time-of-voting registrants as such registrants register without affecting the length L of the binary voting vector. Any unassigned dummy registrations can have undervote ballots automatically submitted on their behalf at the expiration of the voting window (poll closure). In this way, the length L of the binary voting vector can be established as a maximum number of voters or a liberal estimate number of voters without knowing the precise number of voters ultimately registered.

As shown in FIG. 2B, the ballot collection servers 220 can then (after registration closure and determination of the value of the voting vector length L) communicate with each other over connections 228 to jointly compute location shares for each voter. For example, secure multi-party computation (SMPC), such as secure multi-party multiplication (SMPM), can be used to compute the location shares such that for any voter Vᵢ, the sum of the location shares r_{1,i}+ . . . +r_{K,i} provided by all of the multiple ballot collection servers 220 is a unique ballot number lᵢ identifying a location in the voting vector, where i is between 1 and N, the number of registered voters, and K is the number of ballot collection servers 220. The ballot number lᵢ is unique in that no two registered voters receive, via their respective voter devices 200, the same ballot number lᵢ. In an example having K=2 ballot collection servers 220, a first ballot collection server can generate location shares (r_{1,l}, . . . r_{1,N}) and a second ballot collection server can generate location shares (r_{2,l}, . . . r_{2,N}), such that lᵢ=r_{1,i}+r_{2,i} is a unique location from 1 to N. No one of the ballot collection servers 220 possesses enough information to determine the ballot number of any voter, ensuring the secrecy of each voter's ballot. As described below with regard to FIG. 4, the SMPC-based generation of the location shares effectively anonymizes the ballot numbers assigned to each of the voters so that each voter has a unique secret location lᵢ in a voting vector.

Before, during, or after the location shares generation shown in FIG. 2B, the ballot collection servers 220 can also independently generate voter shares for each of the voters. For example, each ballot collection server can generate, for each voter, two random or pseudo-random numbers x_{k,i}, x′_{k,i} as the voter shares, where k is the number of the ballot collection server (a number between 1 and K, inclusive) and i is the number of the voter (a number between 1 and N, inclusive). The numbers x_{k,i}, x′_{k,i} can be generated in accordance with certain constraints, as described in greater detail below. As described below with regard to Table 1, the voter shares help generate a ballot for each voter that is secrecy-maintaining in that the ballot can be published without revealing the identity of any voter associated with any particular choice selected in the ballot.

FIG. 2C illustrates connections 230 between the N voter devices 200 and the K ballot collection servers 220 for shares transmission, voting, and ballot collection and tallying. The connections 230 can be persistent or non-persistent. For example, the connections 230 can be established a first time for shares transmission (from ballot collection servers 220 to voter devices 200), subsequently disestablished, then later re-established for ballot collection (transmission of ballots from voter devices 200 to ballot collection servers 220). The connections 230 need not be established contemporaneously and can instead be established or disestablished on an individual basis.

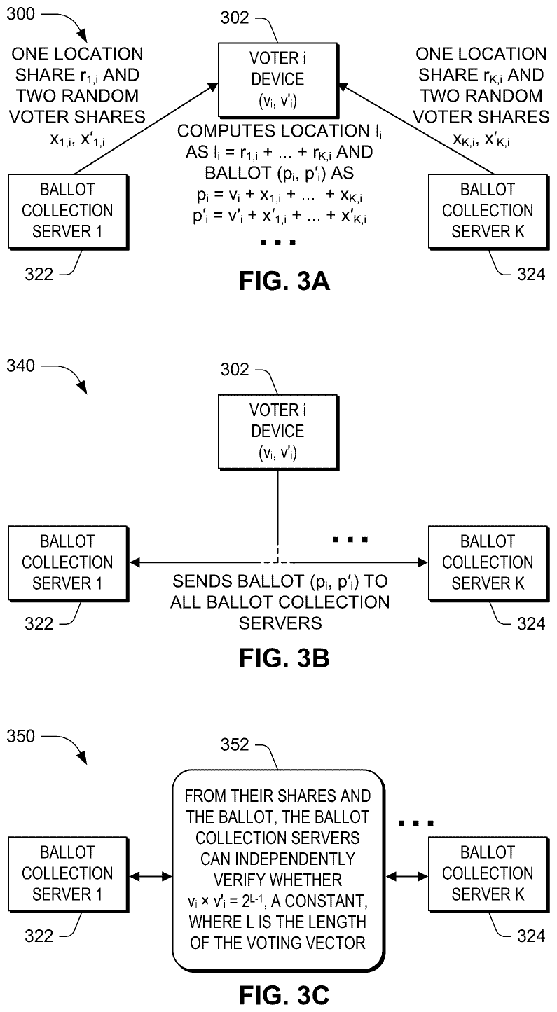

Before or after a voter makes a choice using a respective one of the voter devices 200, such as first voter device 202, second voter device 204, or Nth voter device 206, the respective one of the voter devices 200 can receive the location and voter shares for the voter from each of the ballot collection servers 220 via connections 230. Each of the voter devices 200 can connect, with authentication, directly to each of the ballot collection servers 220 to receive respective location and voter shares. For example, each of the voter devices 200 can receive a set of three shares, consisting of one location share and two voter shares, from each of the ballot collection servers 220, for a total of 3K shares per voter device (3KN shares for the election). In an example having two ballot collection servers 220, when one of the voter devices 200 logs into the electronic voting system to vote, the voter device receives location shares r_{1,i} and r_{2,i} from the respective ballot collection servers and adds these two location shares to compute the voting device's unique location i=riij+r₂,i in a voting vector. Based on this unique secret location lᵢ and the voter's choice from among the available options in the election, the voter's respective voter device can compute the voter's one-hot (or, in some examples, one-cold) vote vᵢ and its bit-reversed permutation v′ᵢ. Based on these individual-voter voting vectors vᵢ, v′ᵢ, the voter device can compute a secrecy-maintaining ballot, as described in greater detail below with regard to FIG. 3A. Using a commitment protocol, such as Pedersen commitment, each voter Vᵢ commits the voter's choice or vote, and each ballot collection server commits its shares.

Thus, based on the received shares and the individual voters' respective choices (from among the available options in the election), each of the voter devices 200 generates a respective secrecy-maintaining ballot, which can be published without revealing a voter's choice, that is, without revealing the choice of an identifiable voter. The secrecy-maintaining ballots are not “secret ballots” in the sense that they remain unpublished. Rather, they can safely be published without compromising the secrecy of the balloting, that is, without revealing which voter, specifically, voted for which option. The secrecy-maintaining ballots can be transmitted back to the ballot collection servers 220 from the voter devices 200 either via the direct connections 230 to the ballot collection servers 220 or via some other intermediary, such as one or more of the election administration servers 210 shown in FIG. 2A. In any case, each of the ballot collection servers 220 receive all of the secrecy-maintaining ballots from all of the respective voter devices 200. Each of the ballot collection servers 220 computes a running tally of votes as ballots are received, and when all ballots are received, or at the close of the voting window, the ballot collection servers 220 each generate a final tally.

The intermediate results and the final tally can be published by the ballot collection servers 220 without risk of exposing secret voter information (the choice of any individual voter, as identifiable to the voter). For example, as shown in FIG. 2D, the ballot collection servers can connect, via connections 232, to one or more election administration servers 210 to publish intermediate or final tallies. The one or more election administration servers 210, in turn, can provide the tallies to the public, for example, via the World Wide Web, and/or an app accessible by voter devices 200.

As shown in FIG. 2E, the ballot collection servers 224 can connect to each other via connections 234 to jointly verify the validity of each ballot after the ballot is received by each of the ballot collection servers 224. The ballot verification process carried out by the ballot collection servers is described in greater detail below with regard to FIG. 3C. The ballot collection servers can also independently verify their tallies, and/or can compare tallies to check for discrepancies. As shown in FIG. 2F, each of the ballot collection servers 220 can connect to the one or more election administration servers 210 via connections 236 to report their verified results and/or to report their concurrence with the results of each of the other ballot collection servers 220. As described in greater detail below, any voter can verify the voter's individual vote, and anyone can tally and verify the vote counts for every choice, thus insuring the transparency and accuracy of the election.

FIGS. 3A through 3C illustrate an example electronic voting process from the perspective of a voter device for an individual voter Vᵢ, such as one of the voter devices 200 in FIGS. 2A through 2D. As shown in FIG. 3A, before or after being used by a registered voter to select a choice from among the available options in an election, voter device 302 receives three shares from each of K ballot collection servers. For example, as shown in FIG. 3A, voter device 302 receives one location share r_{1,i} and two random or pseudo-random voter shares x_{1,i}, x′_{1,i} from first ballot collection server 322, and one location share r_{K,i} and two random or pseudo-random voter shares x_{K,i}, x′_{K,i} from Kth ballot collection server 324. The large ellipses in FIGS. 3A through 3C indicate that there can be more than the two ballot collection servers 322, 324 specifically illustrated. Thus, voter device 302 can further receive one location share and two random or pseudo-random voter shares from each of one or more other, not-illustrated ballot collection servers designated by respective numbers between 1 and K.

As further indicated in FIG. 3A, voter device 302 then can compute its secret location lᵢ as lᵢ=r_{1,i}+ . . . +r_{K,i}; can compute its vote vᵢ and bit-reversed vote v′ᵢ, based on the voter's selected choice and the secret location lᵢ, and can compute its secrecy-maintaining ballot (pᵢ, p′ᵢ) as pᵢ=vᵢ+x_{1,i}+ . . . +x_{K,i} and p′ᵢ=v′ᵢ+x′_{1,i}+ . . . +x′_{K,i}. The secrecy-maintaining ballot can thus be computed as the sum of the vote (the choice at the secret location) and voter shares received from all of the K ballot collection servers.

As shown in FIG. 3B, the voter device 302 then transmits its secrecy-maintaining ballot (pᵢ, p′ᵢ) to all of the ballot collection servers, including the first ballot collection server 322, the Kth ballot collection server 324, and any other ballot collection servers that participate in the election. As shown in FIG. 3C, all of the ballot collection servers, including the first ballot collection server 322, the Kth ballot collection server 324, and any other ballot collection servers that participate in the election, can communicate to jointly verify the validity of the ballot (pᵢ, p′ᵢ). In the general case that there are more than two ballot collection servers (K>2), the ballot collection servers can verify the ballot (pᵢ, p′ᵢ) of each voter Vᵢ as:

$$( {p}_{i} - {\sum }_{k = 1}^{K} {x}_{k , i} ) ( {p}_{i}^{′} - {\sum }_{k = 1}^{K} {x}_{k , i}^{′} ) = {v}_{i} * {v}_{i}^{′} {=}^{?} {2}^{L - 1} \qquad ( 1 )$$

that is,

$${p}_{i} {p}_{i}^{′} - {\sum }_{k = 1}^{K} ( {p}_{i} {x}_{k , i}^{′} + {p}_{i}^{′} {x}_{k , i} ) + {\sum }_{k = 1}^{K} {x}_{k , i} {x}_{k , i}^{′} + {\sum }_{k , h ∈ \{ 1 … K \} and k != h} ( {x}_{k , i} {x}_{h , i}^{′} + {x}_{k , i}^{′} {x}_{h , i} ) {=}^{?} {2}^{L - 1} \qquad ( 2 )$$

where each pair of ballot collection servers numbered k and h compute the respective sum x_{k,i}x′_{h,i}+x′_{k,i}x_{h,i} using an STPM protocol twice as follows:

$${x}_{k , i} {x}_{h , i}^{′} = {r}_{k , i , h} + {r}_{h , i , k}^{′} \qquad ( 3 )$$

$$and$$

$${x}_{k , i}^{′} {x}_{h , i} = {r}_{k , i , h}^{′} + {r}_{h , i , k} \qquad ( 4 )$$

The ballot collection server numbered k computes r_{k,i,h} and r′_{k,i,h} and the ballot collection server numbered h computes r_{h,i,k} and r′_{h,i,k}. The computation of the sum x_{k,i}x′_{h,i}+x′_{k,i}x_{h,i} can be performed by each pair of ballot collection servers in advance of ballot collection after each ballot collection server generates two shares for each voter. In other examples, this computation is performed during or after ballot collection. After a voter Vᵢ publishes its ballot (pᵢ, p′ᵢ), each ballot collection server, numbered k, can compute a respective sum-of-products (SP) as:

$$S {P}_{k , i} = - {p}_{i} {x}_{k , i}^{′} - {p}_{i}^{′} {x}_{k , i} + {x}_{k , i} {x}_{k , i}^{′} + {\sum }_{h = 1 , h ! = k}^{K} ( {r}_{k , i , h} + {r}_{k , i , h}^{′} ) \qquad ( 5 )$$

where result values r_{k,i,h} and r′_{k,i,h} are the result values obtained when the ballot collection servers k and h compute their share products x_{k,i}x′_{h,i} and x′_{k,i}x_{h,i} using an STPM protocol. Each ballot collection server numbered k can publish its sum-of-products SP_{k,i} for the ith voter Vᵢ, and/or each pair of ballot collection servers numbered k and h can exchange their respective sums-of-products SP_{k,i}, SP_{h,i} for the ith voter Vᵢ. Consequently, each ballot collection server (numbered k) can independently compute and verify, for each other ballot collection server (numbered h) and for each voter Vᵢ:

$${p}_{i} {p}_{i}^{′} + {\sum }_{h = 1}^{K} S {P}_{h , i} {=}^{?} {2}^{L - 1} \qquad ( 6 )$$

Based on the left side of Equation 6 not equaling 2^{L-1}, it can be determined that the voter Vᵢ must have cast a ballot voting for more than one option, or otherwise published an incorrect ballot. The ballot for the voter Vᵢ can accordingly be rejected or discounted in a final tally as evidencing potential misbehavior or tampering. In this way, the two ballot collection servers can effectively independently verify that the product of the vote vᵢ and the bit-reversed vote v′ᵢ is 2^{L-1}, where L is the length of the voting vector. That the product vᵢ*v′ᵢ should equal 2^{L-1}, absent misbehavior or tampering, is true irrespective of which voter's vote is examined and what choice the voter made.

In the special case that there are only two ballot collection servers (K=2), the two ballot collection servers can verify:

$$( {p}_{i} - {x}_{1 , i} - {x}_{2 , i} ) ( {p}_{i}^{′} - {x}_{1 , i}^{′} - {x}_{2 , i}^{′} ) = {v}_{i} * {v}_{i}^{′} {=}^{?} {2}^{L - 1} \qquad ( 7 )$$

using an STPM protocol twice to obtain share products x_{1,i}x′_{2,i} and x′_{1,i}x_{2,i}, as follows. Using an STPM protocol a first time, the first ballot collection server and the second ballot collection server can compute r_{1,i} and r′_{2,i}, respectively, such that:

$${r}_{1 , i} + {r}_{2 , i}^{′} = {x}_{1 , i} * {x}_{2 , i}^{′} \qquad ( 8 )$$

Using an STPM protocol a second time, the first ballot collection server and the second ballot collection server can compute r′_{1,i} and r_{2,i}, respectively, such that:

$${{r}^{′}}_{1 , i} + {r}_{2 , i} = {{x}^{′}}_{1 , i} * {x}_{2 , i} \qquad ( 9 )$$

The first ballot collection server can then compute its sum-of-products:

$${SP}_{1 , i} = {r}_{1 , i} + {{r}^{′}}_{1 , i} - {p}_{i} {{x}^{′}}_{1 , i} - {{p}^{′}}_{i} {x}_{1 , i} + {x}_{1 , i} {{x}^{′}}_{1 , i} \qquad ( 10 )$$

and the second ballot collection server can compute its sum-of-products:

$${SP}_{2 , i} = {r}_{2 , i} + {{r}^{′}}_{2 , i} - {p}_{i} {{x}^{′}}_{2 , i} - {{p}^{′}}_{i} {x}_{2 , i} + {x}_{2 , i} {{x}^{′}}_{2 , i} \qquad ( 11 )$$

The first and second ballot collection servers can then exchange their respective sums-of-products SP_{1,i} and SP_{2,i}. The first and second ballot collection servers then can each independently verify:

$${SP}_{1 , i} + {SP}_{2 , i} + {p}_{i} {{p}^{′}}_{i} {=}^{?} {2}^{L - 1} \qquad ( 12 )$$

Based on the left side of Equation 12 not equaling 2^{L-1}, it can be determined that the voter Vᵢ must have cast a ballot voting for more than one option, or otherwise published an improper ballot. The ballot for the voter Vᵢ can accordingly be rejected or discounted in a final tally as evidencing potential misbehavior or tampering. Examples of handling of one or more discounted votes are described below with regard to the examples of FIG. 5 and Tables 1 and 2.

FIGS. 3A through 3C thus illustrate that the system 100 of FIG. 1 can employ, as a technical solution, “in-process verification and enforcement”: ballot collection servers can jointly check the validity of each ballot upon its being cast or any time thereafter and can enforce each voter Vᵢ to choose one and only one option among the options made available in the election, using SMPC, without the ballot collection servers sharing their secret shares with each other directly.

The electronic voting systems, methods, and computer-readable media described herein can make use of any SMPC, SMPM, secure two-party computation (STPC), or STPM protocols known in the art to effect the joint computations described herein. In an example STPM protocol, a first ballot collection server creates a Paillier cryptosystem and gives its public key to a second ballot collection server. The first ballot collection server generates a first unencrypted secret share x₁ (for example, as a random or pseudo-random number) and encrypts the first unencrypted secret share x₁ using a public key of the first ballot collection server, for which only the first ballot collection server has a corresponding private key, resulting in a first encrypted secret share y₁=E(x₁). The second ballot collection server generates a second unencrypted secret share x₂, generates a random or pseudo-random result value r₂, and then computes a second encrypted secret share y₂ as:

$${y}_{2} = {y}_{1}^{{x}_{2}} \times {E ( {r}_{2} )}^{- 1} \qquad ( 13 )$$

The second ballot collection server then sends this second encrypted secret share y₂ to the first ballot collection server. The first ballot collection server then decrypts the second encrypted secret share y₂ to obtain a result value r₁. As a result, the product of the unencrypted secret shares x₁ and x₂, which are held separately by the first and second ballot collection servers, respectively, equals the sum of the result values r₁ and r₂:

$${x}_{1} \times {x}_{2} = {r}_{1} + {r}_{2} \qquad ( 14 )$$

In FIGS. 1, 2A through 2F, and 3A through 3C, communication connections between entities (voter devices, election administration servers, ballot collection servers) are represented by lines connecting the entities. The connections can be wired or wireless, and can be direct or indirect (such as over a network, such as the internet). Any message transferred over any of the communication connections can be confidentiality-and-integrity-protected from interception, interference, or transmission loss using methods known in the secure communications arts. As examples, when a voter device transmits a ballot to any ballot collection server, the ballot can be integrity-protected via a physically secure channel (for example, with all servers deployed with one or more voting booths and voters personally appearing at the voting booth to cast their ballots) or using cryptographic algorithms, such as algorithms using one or more message authentication codes and one or more digital signatures. For another example, when a ballot collection server transmits a location share and two voter shares to a voter device, the transmission can be confidentiality-and-integrity-protected via either a physical secure channel or using encryption, one or more message authentication codes, and one or more digital signatures.

FIG. 4 is a diagram of an example tallied voting vector 420 and individual choice tallies 430, 440 for an example election between two options (a “Blue Choice” and a “Red Choice”) with N voters using N voter devices 400 participating. The voter devices 400 include first voter device 402, second voter device 404, third voter device 406, fourth voter device 408, penultimate voter device 410, and last (Nth) voter device 412. The tallied voting vector 420 can be computed as the sum of all of the votes from all of the N individual voter devices, and is thus also of length L. Because there are two options in the election of the illustrated example in FIG. 4, each choice is two bits in length, with only one of the two bits being asserted for each vote. In an election with three options, each choice would be three bits in length, with only one of the three bits being asserted, and so on. The locations of the votes in the tallied voting vector are anonymized 422 by the computation of the secret location (individual voter ballot number) lᵢ for each voter Vᵢ, as described above. Each voter's choice is stored at the voter's respective secret location in the voting vector. In the illustrated example, the second voter device 404 computes a unique secret location l₂ that is the penultimate location 424 in the tallied voting vector 420, and the third voter device 406 computes a different unique secret location l₃ that is the second location 426 in the tallied voting vector 420. The other voter devices similarly compute other unique secret locations in the tallied voting vector 420.

As shown in FIG. 4, a voter using the penultimate voter device 410 selects the Red Choice, so that the two-bit choice in the first location in the tallied voting vector 420 is “10” in binary (as read from bottom up in FIG. 4), or 2¹. A voter using the third voter device 406 selects the Blue Choice, so that the two-bit choice in the second location 426 in the tallied voting vector 420 is “01” in binary. A voter using the Nth voter device 412 also selects the Blue Choice, so that the two-bit choice in the third location in the tallied voting vector 420 is also “01” in binary. A voter using the fourth voter device 408 selects the Red Choice, so that the two-bit choice in the fourth location in the tallied voting vector 420 is “10” in binary. A voter using the second voter device 404 selects the Red Choice, so that the two-bit choice in the penultimate location in the tallied voting vector 420 is “10” in binary. A voter using a voter device not specifically illustrated in FIG. 4, having the last location in the tallied voting vector 420 as its unique secret location, selects the Blue Choice, so that the two-bit choice in the last location in the tallied voting vector 420 is “01” in binary. The choice of the voter using the first voter device 402 is at a location between the fourth location and the penultimate location in the tallied voting vector 420, and is not specifically illustrated in FIG. 4. The secret locations identifying voters with their respective choices remain non-public and are known only to the individual voters. Thus, the location mapping 422 is secret, and the tallied voting vector 420 and choice tallies 430, 440 are public.

The Blue Choice tally 430 can be determined by counting up the number M of Blue Choice votes in the tallied voting vector 420. The Red Choice tally 440 can be determined by counting up the number N minus M (assuming no undervotes) of Red Choice votes in the tallied voting vector 420. The election example of FIG. 4 employs only two options, but in some examples, an election of two (or more) selectable options can implement a third (or additional), default option, for example, a non-selectable default option, representative of the condition that the voter selects no choice, to count undervotes. Undervotes can also be handled without employing a default option, as described in greater detail below. The tallying of votes can be performed by any ballot collection server, or, because the tallied voting vector 420 can be safely published without sacrificing voter privacy (that is, without publicly associating any particular vote with the voter who cast it), the tallying of votes can be performed by anyone. Because each of the voter devices 400 retains its respective secret location, each voter can verify that the voter's own recorded choice in a tallied voting vector, such as example tallied voting vector 420, matches the choice cast by the respective voter. The information about the respective secret locations can be stored directly in memory or data storage of the respective voter device, or, in some examples, in a remote or cloud location securely accessible only by the respective voter device and not by any other device.

FIG. 4 thus illustrates that the system 100 of FIG. 1 can employ as a technical solution the tallied voting vector 420 and choice tallies 430, 440 that are transparent, visual, and verifiable. Each voter Vᵢ has a unique secret location lᵢ known only to the respective voter Vᵢ that serves as an index in the voter's voting vector vᵢ and in the tallied voting vector Σvᵢ. Each voter Vᵢ can see the voter's own vote in the published tallied voting vector Σvᵢ and can thus verify that the voter's recorded and tallied choice at the voter's location lᵢ is indeed the choice that the voter selected when voting. In some examples, a voter device can be configured to automatically check that the voter's vote was accurately recorded in a final tally by comparing the corresponding voter's committed vote, as stored in the voter device, with the vote published at the voter's secret location lᵢ in the published tallied voting vector. Moreover, anyone can perform their own tallies of the options from the published tallied voting vector to verify the winner of an election performed using the system 100 of FIG. 1. In FIG. 4, only the mapping of the ballot numbers 422 is secret (to the respective individual voter devices 400). The tallied voting vector 420 and choice tallies 430, 440 are public.

FIG. 5 is a diagram of an example tallied voting vector 520 of length L=8 bits and individual voting vectors 550, 560, each also of length L=8 bits, for two of the voters using voter devices 508, 506 in an example election between two options (a “Blue Choice” and a “Red Choice”). Four voters using four voter devices 502, 504, 506, 508 participate in the example election shown in FIG. 5. A first voting vector 550 represents the vote v₄ cast by a fourth voter V₄ using fourth voter device 508, with the fourth voter's secret location 14 being the first location 552 in the first voting vector 550 and thus also the first secret location 522 in the tallied voting vector 520. A second voting vector 560 represents the vote v₃ cast by a third voter V₃ using third voter device 506, with the third voter's secret location l₃ being the fourth location 564 in the second voting vector 560 and thus also the fourth secret location 524 in the tallied voting vector 520.

In the example election illustrated in FIG. 5, the fourth voter V₄ selects the Red Choice using the fourth voter device 508. Accordingly, the first location 552 of the first voting vector 550 contains the binary value “10” (as read bottom-up), with the asserted (logical “1”) bit representing the vote for the Red Choice and the Blue Choice bit being left unasserted (logical “0”). The voting vector 550 thus represents the vote v₄ having a binary value “00000010”, or 2¹, when the voting vector 550 is read bottom-up, or a bit-reversed vote v′₄ having a binary value “01000000”, or 2⁶, when the voting vector 550 is read top-down. The product of these two differently ordered readings of the voting vector 550, v₄*v₄, is equal to a vote verification product 2⁷, which product is a constant 2^{L-1} for any vote vᵢ properly cast in the election, irrespective of the voter or the choice cast by the voter. The illustrated example encodes a single voter's vote as one-hot voting vector, but in other examples, not illustrated, a one-cold voting vector can be used.

Using the third voter device 506, the third voter V₃ in the example election of FIG. 5 selects the Blue Choice. Accordingly, the fourth location 564 of the second voting vector 560 contains the binary value “01” (as read bottom-up), with the asserted (logical “1”) bit representing the vote for the Blue Choice and the Red Choice bit being left unasserted (logical “0”). The voting vector 560 thus represents the vote v₃ having a binary value “01000000”, or 2⁶, when the voting vector 560 is read bottom-up, or a bit-reversed vote v′₃ having a binary value “00000010”, or 2¹, when the voting vector 560 is read top-down. The product of these two differently ordered readings of the voting vector 560, v₃*v′₃, is, as expected, also equal to the vote verification product 2⁷. Should the product vᵢ*v′ᵢ for any voter not be equal to the expected vote verification product 2^{L-1} (2⁷ in the example election of FIG. 5), it can be determined that the vote is not valid, and may be the result of voter or voter device misbehavior, hacking, or some other problem. The vote can then be discounted or other remedial action can be taken. As an example of such other remedial action, any ballot collection server receiving a faulty vote from a voter device can connect to the voter device to request transmission or retransmission of a ballot properly encoding the earlier-committed vote stored by the voter device, and the voter device can comply by transmitting or retransmitting the requested ballot to the requesting ballot collection server(s).

In the example of FIG. 5, as noted above, the secret location of the fourth voter V₄ in the tallied voting vector 520 is the first location (at the top of the vector 520 as it is illustrated in FIG. 5), and the secret location of the third voter V₃ in the tallied voting vector 520 is the fourth location (at the bottom of the vector 520 as it is illustrated in FIG. 5). Additionally, the secret location of the first voter V₁ in the tallied voting vector 520 is the second location, and the secret location of the second voter V₂ in the tallied voting vector 520 is the third location. Voting vectors for votes v₁ and v₂ are not specifically illustrated in FIG. 5, but their binary values are “00000100” (2²) and “00100000” (2⁵), respectively The value of the tallied voting vector is equal to the sum of all votes vᵢ, with i from 1 to N. In the illustrated example, the tallied voting vector 520 is thus v₁+v₂+v₃+v₄, which is “01100110” in binary, or 102 in decimal. The tallied voting vector 520 can be examined by anyone to determine the tallies associated with the respective individual options, as described above with regard to FIG. 4. The tallied voting vector 520 can be examined by any of the individual voters V₁, V₂, V₃, V₄, who each have knowledge of their own respective secret locations l₁, l₂, l₃, l₄, as stored in their respective voter devices 502, 504, 506, 508, to verify that their votes as cast correctly appear in the tallied voting vector 520.

FIG. 5 thus illustrates that the system 100 of FIG. 1 can employ as a technical solution “mutual lock voting”: each voter's private voting vector vᵢ can be converted to two numbers, the product of which is constant across all voters' votes. This constant is dependent only on the number of options in the election and the number of registered voters. In FIG. 5, the individual voters' secret locations lᵢ and voting vectors, such as vectors 550 and 560, are private (to the respective individual voters), as are the multiplicands vᵢ and multipliers v′ᵢ that are multiplied to give the vote verification product 2^{L-1}. The vote verification product 2^{L-1} itself and the tallied voting vector 520 are public.

Publication of public election information can take place, for example, via a real-time public bulletin board. The public bulletin board can be hosted, for example, by one or more of the one or more election administration servers described above with regard to FIGS. 2A, 2D, and 2F, or by another system, and can be served, for example, over the World Wide Web, and/or over an app subscribed to by individual voter devices. The public bulletin board can serve the function of translating secrecy-maintaining ballots, as computed by individual voter devices as shown in FIG. 3A, into individual votes. In some examples, data written to the public bulletin board is only appendable, not erasable or re-writable. The public bulletin board can be used, for example, to publish all non-secret election information, including secrecy-maintaining ballots. The public bulletin board can, in some examples, permit aggregation of secret ballots by anyone as ballots are being cast in real time. In other examples, the public bulletin board can be updated starting only after certain triggering events or times, such as the closing of polls, so as to avoid influencing election outcomes.

Table 1 illustrates the computation of the secrecy-maintaining ballot pᵢ as the sum of a vote vᵢ, a first secret share x_{1,i} from a first ballot collection server, and a second secret share x_{2,i} from a second ballot collection server for an example four-voter election like the example illustrated in FIG. 5. In Table 1, the vote vᵢ is given in decimal-representation equivalent of the corresponding binary voting vector, and is always a power of two for a well-formed vote.

TABLE 1

| | Secret | | | Voter | Voter | |
|---|---|---|---|---|---|---|
| | loca- | | | share | share x_{2,i} | |
| | tion | | | x_{1,i} from | from | |
| | (ballot | | | first | second | |
| | num- | | | ballot | ballot | Secrecy- |
| Voter | ber) | | Vote | collection | collection | maintaining |
| Vᵢ | lᵢ | Choice | vᵢ | server | server | ballot pᵢ |
| V₁ | 2 | Blue Choice | 32 | 5 | 15 | 52 |
| V₂ | 3 | Red Choice | 4 | 1 | −10 | −5 |
| V₃ | 4 | Blue Choice | 2 | −20 | 11 | −7 |
| V₄ | 1 | Red Choice | 64 | 14 | −16 | 62 |

In Table 1, only the secrecy-maintaining ballot pᵢ is published. The secret location, choice, and vote columns remain secret to the respective individual voters, and the secret shares columns remain secret to the respective individual voters and the respective ballot collection servers that generated the secret shares. For any ballot collection server numbered k, the secret voter share x_{k,i} is determined randomly or pseudo-randomly by the kth ballot collection server, working independently of any other ballot collection servers, and not using multi-party computation, but with the constraint that:

$${\sum }_{i = 1}^{N} {x}_{k , i} = 0 \qquad ( 15 )$$

This constraint can be satisfied, for example, by computing the Nth secret voter share x_{k,N} for the last-numbered voter V_{N} as:

$${x}_{k , N} = - {\sum }_{i = 1}^{N - 1} {x}_{k , i} \qquad ( 16 )$$

This constraint can be observed in the x_{1,i} and x_{2,i} columns of Table 1 by noting that 14=−(5+1+−20) and −16=−(15+−10+11). The value of the secret voter share x_{k,i} can, in some examples, be further constrained to fall within a range of values that can be related to the length L of a voting vector for the election. For example, the value of the secret voter share x_{k,i} can, in some examples, be constrained to fall within the range [−2^{L-1} 2^{L-1}−1]. For example, in the example of Table 1, the voter share values x_{1,i} and x_{2,i} can be constrained to fall within the range −128 and 127. Not shown, a table similar to Table 1 can be constructed for bit-reversed vote v′ᵢ, with the counterpart secrecy-maintaining ballot p′ᵢ computed as the sum of the bit-reversed vote v′ᵢ and secret voter shares x′_{1,i} and x′_{2,i}. In such a table, v′ᵢ=4, v′₂=32, v′₃=64, and v′₄=2. For any ballot collection server numbered k, the secret voter share x′_{k,i} is determined randomly or pseudo-randomly by the kth ballot collection server, working independently of any other ballot collection servers, and not using multi-party computation, but with the constraint that:

$${\sum }_{i = 1}^{N} {{x}^{′}}_{k , i} = 0 \qquad ( 17 )$$

This constraint can be satisfied, for example, by computing the Nth secret voter share x′_{k,N} for the last-numbered voter V_{N} as:

$${{x}^{′}}_{k , N} = - {\sum }_{i = 1}^{N - 1} {{x}^{′}}_{k , i} \qquad ( 18 )$$

Thus, the secret voter share x′_{k,i} has no relationship to the secret voter share x_{k,i} and is not necessarily (and is not usually) the bit-reversal permutation of the secret voter share x_{k,i}.

As shown in Table 1, the secrecy maintaining ballot p₁=52 for the first voter V₁ using the first voter device 502 is computed, by the first voter device 502, as the sum of the first vote v₁, the first voter's secret share x_{1,1} from a first ballot collection server, and the first voter's secret share x_{2,1} from a second ballot collection server (32+5+15=52). The secrecy maintaining ballot p₂=−5 for the second voter V₂ using the second voter device 504 is computed, by the second voter device 504, as the sum of the second vote v₂, the second voter's secret share x_{1,2} from the first ballot collection server, and the second voter's secret share x_{2,2} from the second ballot collection server (4+1+−10=−5). The secrecy maintaining ballot p₃=−7 for the third voter V₃ using the third voter device 506 is computed, by the third voter device 506, as the sum of the third vote v₃, the third voter's secret share x_{1,3} from the first ballot collection server, and the third voter's secret share x_{2,3} from the second ballot collection server (2+−20+11=−7). The secrecy maintaining ballot p₄=62 for the fourth voter V₄ using the fourth voter device 508 is computed, by the fourth voter device 508, as the sum of the fourth vote v₄, the fourth voter's secret share x_{1,4} from the first ballot collection server, and the fourth voter's secret share x_{2,4} from the second ballot collection server (64+14+−16=62). Not shown by Table 1, the second component of the secrecy-maintaining ballot p′ᵢ can be computed similarly, by the respective voter devices 502, 504, 506, 508, by summing the respective bit-reversed votes v′ᵢ with the respective secret shares x′_{1,i} and x′_{2,i}.

Table 2 illustrates the dynamic incremental aggregation of votes based on the computed of the secrecy-maintaining ballots pᵢ as the ballots are collected and published for the example four-voter election like the example illustrated in FIG. 5.

TABLE 2

| Voter Vᵢ | Secrecy-maintaining ballot pᵢ | Aggregation |
|---|---|---|
| V₂ | −5 | −5 |
| V₁ | 52 | 47 |
| V₄ | 62 | 109 |
| V₃ | −7 | 102 |

The aggregation column of Table 2 represents a running total of the values of the secrecy maintaining ballots pᵢ. In the example of Table 2, the second voter device 504 casts its ballot first in time among the four voters, and the aggregation after that first ballot is cast is −5, the value of p₂. The first voter device 502 casts its ballot second in time among the four voters, and the aggregation after that second ballot is cast is p₂+p₁=−5+52=47. The fourth voter device 508 casts its ballot third in time among the four voters, and the aggregation after that third ballot is cast is p₂+p₁+p₄=−5+52+62=109. The third voter device 506 casts its ballot fourth in time among the four voters, and the aggregation after that fourth ballot is cast is p₂+p₁+p₄+p₃=−5+52+62+−7=102. So long as the secrecy-maintaining ballots are published (for example, to the real-time public bulletin board), aggregation of the secrecy-maintaining ballots can be performed by anyone, contemporaneous with their being cast, in real time. In Table 2, the aggregation partial sums −5, 47, and 109 contain no information about any votes capable of being tallied. The last aggregation 102=32+4+2+64 (“01100110” binary) exposes all the votes and permits tallying. Voters can then verify their votes visually. Table 2 thus illustrates the dynamic incremental ballot aggregation and tallying features of the electronic voting systems and methods described herein. Similar aggregation can be performed for the second component of the secrecy-maintaining ballot p′ᵢ.

In some examples in which voters fail to submit votes, undervote ballots can be automatically submitted for all such voters at a voting deadline (poll closure). An undervote ballot can indicate a choice of a non-selectable option that is additional to the selectable options. The undervote ballots can be submitted either by the corresponding voter devices or by some other system.

In some cases, ballot collection servers may decide or agree to discount certain votes, for example, as being undervotes or overvotes, or in some way as evidencing misbehavior or tampering. In some examples in which one or more votes are discounted, all the ballot collection servers can be configured to publish their proper voter share sums σₖ, σ′ₖ for voters who properly voted in an election (that is, for votes that are not discounted as being, for example, either undervotes nor overvotes), the proper voter share sums σₖ, σ′ₖ being computed as:

$${σ}_{k} = {\sum }_{i = 1 and ith ballot has passed verification}^{N} {x}_{k , i} \qquad ( 19 )$$

$$and$$

$${{σ}^{′}}_{k} = {\sum }_{i = 1 and ith ballot has passed verification}^{N} {{x}^{′}}_{k , i} \qquad ( 20 )$$

where i is not a number of a voter Vᵢ whose vote vᵢ is discounted from the tally (for example, as representing an undervote or overvote). The publication of the proper voter share sums σₖ, σ′ₖ does not compromise ballot anonymity or vote anonymity. In instances in which proper voter share sums σₖ, σ′ₖ are published, the tallied voting vector is computed as:

$${\sum }_{i = 1}^{N} {p}_{i} - {\sum }_{k = 1}^{N} {σ}_{k} \qquad ( 21 )$$

and the reverse tallied voting vector is computed as:

$${\sum }_{i = 1}^{N} {{p}^{′}}_{i} - {\sum }_{k = 1}^{N} {{σ}^{′}}_{k} \qquad ( 22 )$$

where only proper ballots pᵢ and p′ᵢ (ballots that are not discounted) are included in the respective ballot sums. In instances in which proper voter share sums σₖ, σ′ₖ are published, each ballot collection server k can also publish commitment number sums Yₖ and Y′ₖ. For example, where a Pedersen commitment protocol is used, the commitment number sums Yₖ and Y′ₖ can be computed as:

$${Y}_{k} = {\sum }_{i = 1}^{N} {y}_{k , i} \qquad ( 23 )$$

$$and$$

$${{Y}^{′}}_{k} = {\sum }_{i = 1}^{N} {{y}^{′}}_{k , i} \qquad ( 24 )$$

where y_{k,i} and y′_{k,i} are random numbers used in Pedersen commitments of the voter shares x_{k,i} and x′_{k,i}, respectively. The homomorphic property of Pedersen commitment allows anyone to verify that:

$${\prod }_{i = 1}^{N} C ( {x}_{k , i} , {y}_{k , i} ) = C ( {σ}_{k} , {Y}_{k} ) \qquad ( 25 )$$

$$and$$

$${\prod }_{i = 1}^{N} C ( {{x}^{′}}_{k , i} , {{y}^{′}}_{k , i} ) = C ( {{σ}^{′}}_{k} , {{Y}^{′}}_{k} ) \qquad ( 26 )$$

where C(x,y) stands for Pedersen commitment of x with a random or pseudo-random number y.

Following from the example in Tables 1 and 2, in an instance in which ballot p₃ remains unsubmitted, unreceived, or is discounted, for example, because voter V₃ fails to submit a ballot, or submits an undervote or overvote, or submits a vote that evidences misbehavior or tampering, the first ballot collection server can publish a first proper voter share sum σ₁=5+1+14=20, and the second ballot collection server can publish a second proper voter share sum σ₂=15+−10+−16=−11. The aggregation after voters V₂, V₁, and V₄ have submitted proper ballots is 109, as shown in Table 2. With voter V₃'s ballot p₃ discounted as unreceived or improper, the tallied voting vector is computed as 109−(20+−11)=100, or “01100100” in binary. Comparing this binary value to the tallied voting vector 520 in FIG. 5, it can be noted that the votes “01”, “10”, “01” of voters V₄, V₁, and V₂ are preserved in the respective first, second, and third two-bit positions in the tallied voting vector “01100100”, and that the fourth position, corresponding to the secret location of voter V₃, is left as an undervote “00” that does not affect the final tally, which can be computed by anyone from the published tallied voting vector as two votes for the Red Choice and one vote for the Blue Choice.

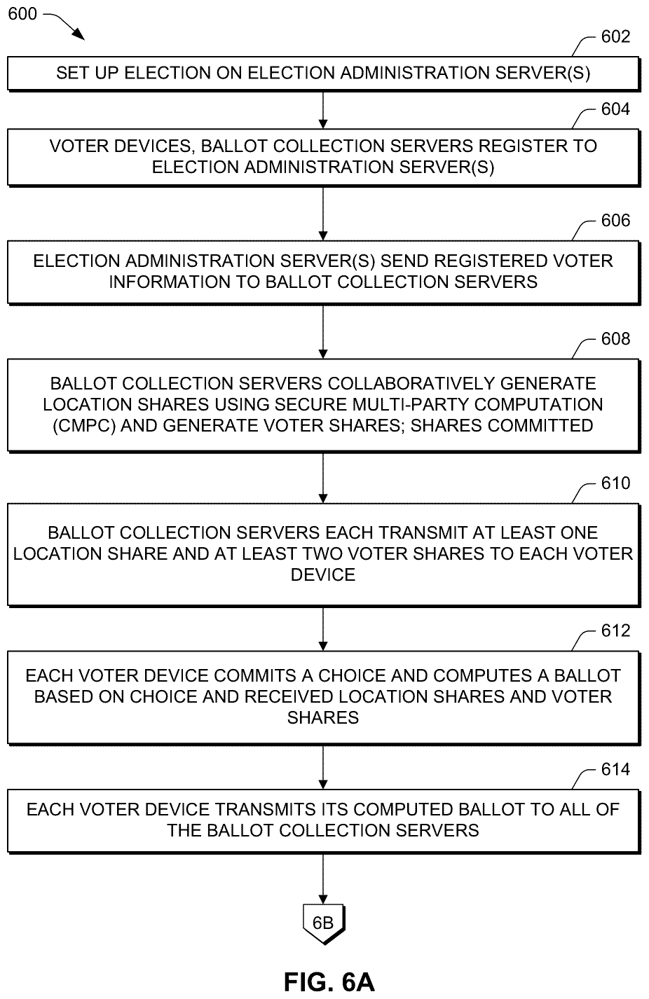

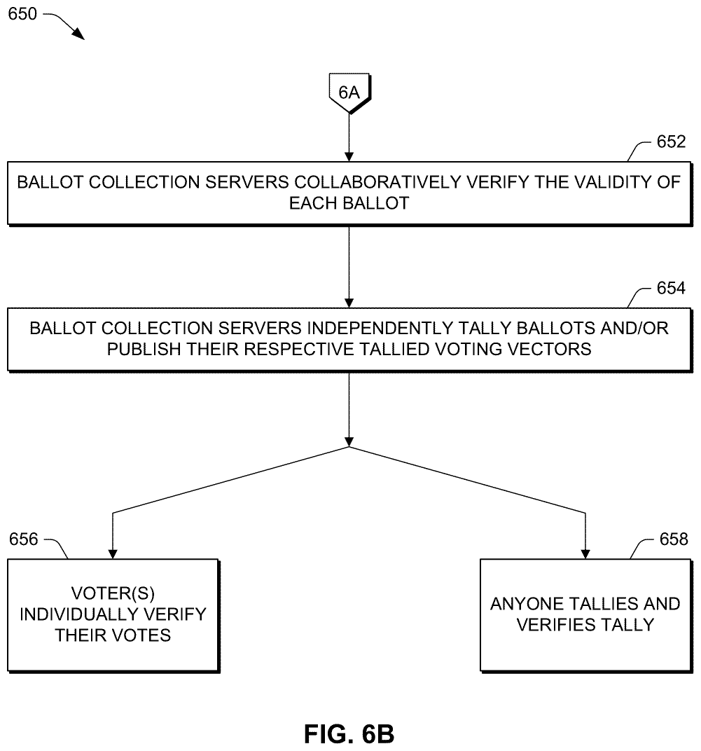

FIGS. 6A and 6B illustrate methods of electronic voting, such as may utilize the system 100 of FIG. 1. With reference to FIG. 6A, in method 600, an election can be set up 602 on one or more election administration server(s). The one or more election administration servers can be, for example, like the one or more election administration servers 210 shown in FIGS. 2A, 2D, and 2F. The setup can include, as examples, entering information about the options available for voter selection, and, in some cases, inputting information about voters eligible for registration. Voter devices (at least three) and ballot collection servers (at least two) can then register 604 with the one or more election administration servers. The voter devices can, for example, be as described above with regard to voter devices 102 and 106 in FIG. 1, 200 in FIGS. 2A and 2C, 302 in FIGS. 3A and 3B, 400 in FIGS. 4, and 502, 504, 506, and 508 in FIG. 5. The ballot collection servers can, for example, be as described above with regard to the ballot collection servers 122 and 126 in FIG. 1, 220 in FIGS. 2A through 2F, and 322 and 324 in FIGS. 3A through 3C. The one or more election administration servers can then send 606 registered voter information to the ballot collection servers. In some examples, the registered voter information can subsequently permit the registered voters to connect to the ballot collection servers to submit their respective ballots. The registered voter information can also be used to determine a number of registered voters N, which, along with the number of selectable or non-selectable options in the election, can be used to determine the bit length L of a voting vector to be used in the election, with L being the product of the number of registered voters N and the number of options.

Still with reference to FIG. 6A, the ballot collection servers can connect to each other to collaboratively generate 608 location shares using secure multi-party computation (SMPC), such as secure multi-party multiplication (SMPM). SMPC can be employed to guarantee that, for each voter Vᵢ, the sum of the location shares r_{1,i}+ . . . +r_{K,i} is a number that is unique to the voter Vᵢ. For example, the sum of the location shares is a number between 1 and N, inclusive, representing a secret ballot number, which is secret in that it is known only to the voter Vᵢ by way of the voter's voter device, which can compute and store the sum. The sum is representative of a unique location in a binary voting vector at which the voter's choice is stored. The choice at the unique location constitutes the voter's vote vᵢ, which is a binary vector of length L. The vote can be as described above with regard to voting vectors 550 and 560 in FIG. 5. The connection between ballot collection servers can be as described above with regard to FIG. 2B. The shares are committed 608 using a commitment protocol, such as Pedersen commitment. The ballot collection servers can then each transmit 610 at least one location share and at least two voter shares to each voter device. For example, the transmission can occur upon a voter device login to vote. The coupling for the transmission 610 can be, for example, as described above with regard to FIG. 2C, and need not occur for all voter devices contemporaneously, but can occur on an individual basis for each voter device.

Still with reference to FIG. 6A, each voter can use a respective voter device to select an option from among the selectable election options as received from the one or more election administration server. Once committed 612, using, for example, Pedersen commitment, as may be carried out using the respective voter device, the selected option constitutes a choice for the voter, and the respective voter device can then compute 612 a secrecy-maintaining ballot based on the voter's choice and the received location shares and voter shares. The secrecy-maintaining ballot can be, for example, as described above with regard to ballots 182 and 184 in FIG. 1, FIG. 2C, FIG. 3A, and Tables 1 and 2. Each voter can transmit 614 its respective computed ballot to all of the ballot collection servers. In some examples, the transmission 614 of ballots can occur on a one-to-one basis, with each voter device connecting directly to each one of the ballot collection servers and transmitting its ballot directly to each ballot collection server. In other examples, the transmission 614 can occur with one or more of the voter devices instead connecting to an election administration server or other intermediary system that can collect ballots and retransmit the ballots to the ballot collection servers.

Now with reference to method 650 FIG. 6B, continuing from method 600 in FIG. 6A, as each ballot is received, the ballot collection servers can collaboratively verify 652 the validity of each incoming ballot, using SMPC, such as SMPM or STPM. This joint checking 652 of ballots can, for example, ensure that each voter Vᵢ votes for one and only one option. The joint checking 652 is done without the ballot collection servers sharing with each other their secret shares directly. Any voter misbehavior or outside hacking of ballots can be caught at this stage. Any faulty ballot can be discounted and/or a request can be made for a voter device that has submitted a faulty ballot to retransmit its ballot. The joint checking can be performed as described above with regard to connection 190 in FIG. 1, connection 234 in FIG. 2E, and connection 352 in FIG. 3C. Ballot collection servers can independently tally 654 ballots and/or can publish 654 their respective tallied voting vectors. The publication can occur to a real-time public bulletin board, as described above with regard to Tables 1 and 2. For example, the publication can be to one or more election administration servers, as described above with regard to FIG. 2D. In some examples, the one or more election administration servers can host the real-time public bulletin board. In other examples, one or more of the ballot collection servers can each host its own real-time public bulletin board. With the ballots and/or tallied voting vectors thus published, voters can individually verify 656 their votes, for example, by visually inspecting a published tallied voting vector and determining that the choice recorded in the voter's secret location, as may have been stored in the voter's respective voting device, matches the committed choice earlier made by the voter during voting. Also, with the ballots and/or tallied voting vectors published, anyone can tally 658 the votes and verify tallies made by ballot collection servers, election administration servers, or other systems, by adding up published ballots and/or by counting choices for respective options in published tallied voting vectors.

Separate functions of a ballot collection server as described above can be distributed amongst different physical or virtual machines and carried out separately by the different physical or virtual machines without departing from the meaning of the term “ballot collection server” as used in this description and in the appended claims. As one example, a first physical or virtual machine of a ballot collection server can be configured to perform location share generation, a second physical or virtual machine of the ballot collection server can be configured to perform voter share generation, and a third physical or virtual machine of the ballot collection server can be configured to perform ballot collection and verification, being in receipt of some or all of the shares generated by the first and second physical or virtual machines. In such an example, all three physical or virtual machines are considered to constitute a single ballot collection server, even if they are arranged to operate in different physical devices and even if they are arranged to perform their functions from locations that are disparate from one another.

As another example, a first physical or virtual machine of a ballot collection server can be configured to perform share generation of both location and voter shares, and a second physical or virtual machine of the ballot collection server can be configured to perform ballot collection and verification, being in receipt of some or all of the shares generated by the first physical or virtual machine. In such an example, as well, both physical or virtual machines are considered to constitute a single ballot collection server, even if they are arranged to operate in different physical devices and even if they are arranged to perform their functions from locations that are disparate from one another. In some examples, two or more ballot collection servers can be arranged to execute their functions from a single physical machine, again, without each departing from the meaning of “ballot collection server” as used in this description and in the appended claims, so long as none of the two or more ballot collection servers operating from the same physical machine collude by, for example, sharing their respective secret shares, one with another.

Similarly, separate functions of a voter device as described above can be distributed amongst different physical or virtual machines and carried out separately by the different physical or virtual machines without departing from the meaning of the term “voter device” as used in this description and in the appended claims. As one example, a first physical or virtual machine of a voter device can be configured to receive a selection of an option as a voter choice, a second physical or virtual machine of the voter device can be configured to receive location shares and voter shares from ballot collection servers, a third physical or virtual machine of the voter device can be configured to perform ballot computation, and a fourth physical or virtual machine of the voter device can be configured to verify that a voter's choice is accurately recorded in an aggregated ballot or tallied voting vector, being in receipt of information about the voter's choice and the voter's secret ballot number (voting vector location) from the first and/or second (and/or third) physical or virtual machines. In such an example, all four physical or virtual machines are considered to constitute a single voter device, even if they are arranged to operate in different physical devices and even if they are arranged to perform their functions from locations that are disparate from one another.

As another example, a first physical or virtual machine of a voter device can be configured to receive a selection of an option as a voter choice, a second physical or virtual machine of the voter device can be configured to receive location shares and voter shares from ballot collection servers and to perform ballot computation, and a third physical or virtual machine of the voter device can be configured to verify that a voter's choice is accurately recorded in an aggregated ballot or tallied voting vector, being in receipt of information about the voter's choice and the voter's secret ballot number (voting vector location) from the first and/or second physical or virtual machines. In such an example, as well, all three physical or virtual machines are considered to constitute a single voter device, even if they are arranged to operate in different physical devices and even if they are arranged to perform their functions from locations that are disparate from one another. In some examples, two or more voter devices can be arranged to execute their functions from a single physical machine, again, without each departing from the meaning of “voter device” as used in this description and in the appended claims, so long as none of the two or more voter devices operating from the same physical machine improperly corrupt the secrecy of the election by, for example, sharing a secret ballot number belonging to one voter with another voter, sharing a choice selected by one voter with another voter, computing one voter's ballot using a choice or location of another voter, or transmitting one voter's computed ballot as another voter's.

The above-described systems, such as system 100 of FIG. 1, can operate using software that encodes instructions on one or more non-transitory computer-readable media. The computer-readable media can be read by general-purpose or special-purposes processors in the voting devices and ballot collection servers. The software can be securely distributed to the voting devices and/or the ballot collection servers using the election administration servers, via the cloud, via an app store, or by another method. The software can be distributed in different forms for the different devices. For example, one portion of the software can be distributed to each of the voter devices, while another portion of the software can be distributed to each of the ballot collection servers. The software portion distributed to each of the voter devices can include, as examples, instructions stored on one or more non-transitory computer-readable media of each of the voter devices that cause the voter devices to perform one or more of: receive and store shares generated by ballot collection servers, present election options to the voter for selection, perform commitment of a voter choice, compute ballots based on the choice and the shares, transmit ballots, compute and store a unique secret location (ballot number), and/or verify the voter's choice is correctly recorded in a tallied voting vector published by one or more ballot collection servers.

The software portion distributed to each of the ballot collection servers can include, for example, instructions stored on one or more non-transitory computer-readable media of each of the ballot collection servers that cause the ballot collection servers to perform one or more of: receive and store information about registered voters, receive or compute a voting vector length L that is based on the number of registered voters and the number of options, compute location shares (collaboratively with the other ballot collection servers) and voter shares, perform commitment of the location and voter shares, transmit the location shares and voter shares to voter devices, receive computed ballots generated by voter devices based on the voter's committed choices and the transmitted location and voter shares, jointly check ballot integrity by collaboration with other ballot collection servers, check for voter misbehavior or external hacking, tally voting vectors, and publish ballots and/or tallied voting vectors. In some examples, considered together, the software portions form a working whole to carry out the electronic voting methods described above and to enable the systems described above. In other examples, each portion, such as a voter device software portion or a ballot collection server software portion, can be considered separately as an example of the invention.

Advantages and benefits of the systems, methods, and computer-readable media described herein include (1) full transparency, in that not only tallies, but also submitted ballots and plain votes can be published and viewable to anyone for verification and individual-voter assurance; (2) full verification; (3) full fairness, in that the systems and methods are configurable for no disclosure of partial results; (4) no need for a central, trusted tallying authorities, in that anyone can tally votes; (5) open, seamless ballot-to-vote transition; (6) resistance to voter misbehavior and outside attacks; (7) ease of understanding and implementation; and (8) long-term voter privacy. Because the secret ballot numbers for each of the voters are generated to be unique by using secret sharing and SMPC, the systems, methods, and computer-readable media described herein have the advantage that individual voters cannot misbehave by choosing ballot numbers that intentionally collide with ballot numbers chosen by other voters, which misbehavior would cause the voting system not to function. Because each voter's vote is obscured in the voter's secrecy-maintaining ballot by summing the voter's vote with voter shares received from multiple ballot collection servers, the secrecy of the ballots is ensured without resorting to ballot-computing processes that involve computationally expensive exponentiation. Furthermore, Pedersen commitment of the voter's vote is unconditionally-hiding (of the vote), resulting in what is termed in the art as “everlasting privacy”.

Because voting vectors enlarge with the number of voters N and the number of options in an election, and the computational time involved with an election carried out using the described systems, methods, or computer-readable media depends on the length of the voting vectors, speed of operation of the system can be realized either through parallel computational methods and/or using precinct-based election systems that limit the number of voters N to a number that maintains the computational times within acceptable limits. As an example, an election can be carried out within a set of precincts each of fewer than ten thousand voters, or fewer than one thousand voters, each precinct having its own set of ballot collection servers, and the tallies provided by different precincts can be summed to arrive at an election result.

The foregoing example systems, methods, and computer-readable media leverage the conflict of interest inherent in opposing parties or candidates, or proponents and opponents of issues, that may be the contestants in an election. Each ballot collection server can be placed in the custody and control of one of the interest-conflicting parties or of a neutral third-party observer. As long as at least two of the ballot collection servers do not collude by sharing information in a way that would break the secrecy of the (n,n) secret sharing on which the proper functionality of the location shares and voter shares rely—which is a reasonable assumption when the at least two ballot collection servers are respectively in the custody and control of interest-conflicted parties, each with no motivation to give the other an unfair advantage in the election—then the electronic voting system, methods, and procedures carried out by the computer-readable media are resistant to the misbehavior of any participant and to outside attacks. Such resistance, along with the verifiability and transparency advantages described above, permits invalid votes and attacks to be detected with high probability. The systems, methods, and computer-readable media described herein thus provide technical improvements over prior voting systems, including prior electronic voting systems, which evince a gap between casting ballots and tallying and verifying votes caused by either disconnection between the ballot-casting process and the vote-tallying process or an opaque transition, for example, due to encryption, from vote-casting to vote-tallying, either of which can damage voter assurance.

Modifications are possible in the described examples, and other examples are possible within the scope of the claims.

1. An electronic voting system comprising:
at least three voter devices each including a computer processor;
at least two ballot collection servers each including a computer processor;
wherein:
each of the ballot collection servers is configured to generate, by communicably connecting to each other of the ballot collection servers and using secure multi-party computation (SMPC), at least one location share for each of the voter devices so that a sum of the location shares for any one of the voter devices from each of the ballot collection servers represents a unique ballot number for a corresponding voter associated with the one of the voter devices, the unique ballot number being known by no individual one of the ballot collection servers;
each of the ballot collection servers is further configured to generate, for each of the voter devices, at least two voter shares as random or pseudo-random values;
each of the ballot collection servers is further configured to commit its location shares and its voter shares using a commitment protocol of the respective ballot collection server;
each of ballot collection servers is further configured to transmit, to each of the voter devices, the at least one location share and the at least two voter shares generated by the respective one of the ballot collection servers for the respective one of the voter devices;
each of the voter devices is configured to receive from a corresponding voter a selection, as a choice of the corresponding voter, of one option from among a plurality of options in an election, the selection made via a user input of the voter device;
each of voter devices is further configured to commit the corresponding voter's choice using a commitment protocol of the respective voter device;
each of the voter devices is further configured to compute a respective ballot based on:
the respective committed choice of the respective one of the voter devices,
the location shares received by the respective one of the voter devices from the ballot collection servers, and
the voter shares received by the respective one of the voter devices from the ballot collection servers; and
each of the voter devices is further configured to transmit the respective ballot via a communication interface of the voter device.

2. The electronic voting system of claim 1, wherein:
each of the ballot collection servers is further configured to receive ballots generated and transmitted by the voter devices; and
each of the ballot collection servers is further configured to, by communicably connecting to each other of the ballot collection servers and using secure multi-party computation (SMPC), jointly check the validity of each received ballot.

3. The electronic voting system of claim 1, wherein:
each of the ballot collection servers is further configured to receive ballots generated and transmitted by the voter devices; and
each of the ballot collection servers is further configured to tally the received ballots at least in part by summing the received ballots to compute a tallied voting vector.

4. The electronic voting system of claim 3, wherein at least one of the voter devices is configured to verify that the choice of the corresponding voter of the at least one of the voter devices is represented in the tallied voting vector based on identifying a vote recorded at a location in the tallied voting vector identified by the unique ballot number for the corresponding voter associated with the at least one of the voter devices, the unique ballot number computed by the at least one of the voter devices as a sum of the location shares received by the at least one of the voter devices from the ballot collection servers, and comparing the identified vote to the committed voter's choice.

5. The electronic voting system of claim 1, wherein the commitment protocol of the respective ballot collection server and the commitment protocol of the respective voter device is Pedersen commitment.

6. The electronic voting system of claim 1, wherein each of the voter devices is configured to compute a respective ballot at least in part by:
computing the unique ballot number of the respective one of the voter devices as a sum of the location shares received by the respective one of the voter devices from the ballot collection servers;
computing a binary voting vector for the respective one of the voter devices as a one-hot or one-cold binary number representative of the choice of the corresponding voter positioned at a location in the binary voting vector designated by the unique ballot number; and
computing the respective ballot of the respective one of the voter devices as a sum of the binary voting vector for the respective one of the voter devices and a set of voter shares, the set of voter shares including at least one voter share received from each of the ballot collection servers.

7. The electronic voting system of claim 6, wherein the set of voter shares is a first set of voter shares including at least a first voter share received from each of the ballot collection servers, and wherein each of the voter devices is further configured to compute a respective reverse ballot at least in part by:
computing a reverse binary voting vector for the respective one of the voter devices as a bit-reversed permutation of the binary voting vector for the respective one of the voter devices; and
computing a respective reverse ballot of the respective one of the voter devices as a sum of the reverse binary voting vector for the respective one of the voter devices and a second set of voter shares, the second set of voter shares including at least a second voter share received from each of the ballot collection servers.

8. An electronic voting method comprising:
each of a plurality of ballot collection servers generating, by communicably connecting to each other of the plurality of ballot collection servers and using secure multi-party computation (SMPC), at least one location share for each of a plurality of voter devices so that a sum of the location shares for any one of the plurality of voter devices from each of the ballot collection servers represents a unique ballot number for a corresponding voter associated with the one of the plurality of voter devices, the unique ballot number being known by no individual one of the plurality of ballot collection servers;
each of the plurality of ballot collection servers generating, for each of the plurality of voter devices, at least two voter shares as random or pseudo-random values;
each of the plurality of ballot collection servers committing its location shares and its voter shares using a commitment protocol of the respective one of the plurality of ballot collection servers;
each of the plurality of ballot collection servers transmitting, to each of the plurality of voter devices, the at least one location share and the at least two voter shares generated by the respective one of the plurality of ballot collection servers for the respective one of the plurality of voter devices;
each of a number of the plurality of voter devices receiving, from a corresponding voter, a selection, as a choice of the corresponding voter, of one option from among a plurality of options in an election, the selection made via a user input of the respective one of the plurality of voter devices;
each of the number of the plurality of voter devices committing the corresponding voter's choice using a commitment protocol of the respective one of the plurality of voter devices;
each of the number of the plurality of voter devices computing a respective ballot based on:
the respective committed choice of the respective one of the plurality of voter devices,
the location shares received by the respective one of the plurality of voter devices from the plurality of ballot collection servers, and
the voter shares received by the respective one of the plurality of voter devices from the plurality of ballot collection servers; and
each of the number of the plurality of voter devices transmitting the respective ballot via a communication interface of the respective one of the plurality of voter devices.

9. The electronic voting method of claim 8, further comprising:
each of the plurality of ballot collection servers receiving the ballots generated and transmitted by the number of the plurality of voter devices; and
each of the plurality of ballot collection servers jointly checking the validity of each received ballot by communicably connecting to each other of the plurality of ballot collection servers and using secure multi-party computation (SMPC).

10. The electronic voting method of claim 8, further comprising:
each of the plurality of ballot collection servers receiving the ballots generated and transmitted by the number of the plurality of voter devices; and
each of the plurality of ballot collection servers tallying the received ballots at least in part by summing the received ballots to compute a tallied voting vector.

11. The electronic voting method of claim 10, further comprising at least one of the plurality of voter devices verifying that the choice of the corresponding voter of the at least one of the plurality of voter devices is represented in the tallied voting vector based on identifying a vote recorded at a location in the tallied voting vector identified by the unique ballot number for the corresponding voter associated with the one of the plurality of voter devices, the unique ballot number computed by the at least one of the voter devices as a sum of the location shares received by the at least one of the plurality of voter devices from the ballot collection servers.

12. The electronic voting method of claim 8, wherein the commitment protocol of the respective one of the plurality of ballot collection servers and the commitment protocol of the respective one of the plurality of voter devices is Pedersen commitment.

13. The electronic voting method of claim 8, further comprising each of the number of the plurality of voter devices computing a respective ballot at least in part by:
computing the unique ballot number of the respective one of the number of the plurality of voter devices as a sum of the location shares received by the respective one of the number of the plurality of voter devices from the plurality of ballot collection servers;
computing a binary voting vector for the respective one of the number of the plurality of voter devices as a one-hot or one-cold binary number representative of the choice of the corresponding voter positioned at a location in the binary voting vector designated by the unique ballot number; and
computing the respective ballot of the respective one of the number of the plurality of voter devices as a sum of the binary voting vector for the respective one of the number of the plurality of voter devices and a set of voter shares, the set of voter shares including at least one voter share received from each of the plurality of ballot collection servers.

14. The electronic voting method of claim 13, wherein the set of voter shares is a first set of voter shares including at least a first voter share received from each of the plurality of ballot collection servers, the method further comprising each of the number of the plurality of voter devices computing a respective reverse ballot at least in part by:
computing a reverse binary voting vector for the respective one of the number of the plurality of voter devices as a bit-reversed permutation of the binary voting vector for the respective one of the number of the plurality of voter devices; and
computing a respective reverse ballot of the respective one of the number of the plurality of voter devices as a sum of the reverse binary voting vector for the respective one of the number of the plurality of voter devices and a second set of voter shares, the second set of voter shares including at least a second voter share received from each of the ballot collection servers.

15-20. (canceled)

21. A method of generating a secrecy-maintaining electronic ballot, the method comprising:
receiving, by a voter computing device, a first location share value from a first ballot collection server and a second location share value from a second ballot collection server;
receiving, by the voter computing device, a first voter share value and a second voter share value from each of the first and second ballot collection servers;
determining, by the voter computing device, a ballot number based on the first and second location values;
determining, by the voter computing device, a vote value and a bit-reversed vote value based on the ballot number and a selected choice;
determining, by the voter computing device, a secrecy-maintaining electronic ballot comprising a first secrecy-maintaining electronic ballot portion and a second secrecy-maintaining electronic ballot portion, wherein the first secrecy-maintaining electronic ballot portion is determined based on the first voter share values received from the first and second ballot collection servers and the vote value, and wherein the second secrecy-maintaining electronic ballot portion is determined based on the second voter share values received from the first and second ballot collection servers and the bit-reversed vote value; and
transmitting, by the voter computing device, the secrecy-maintaining electronic ballot to each of the first and second ballot collection servers.

22. The method of claim 21, wherein the first location share value received from the first ballot collection server and the second location share value received from the second ballot collection server are cryptographically-generated location share values.

23. The method of claim 21, wherein the first location share value received from the first ballot collection server and the second location share value received from the second ballot collection server are generated using secure multi-party computation.

24. The method of claim 21, wherein determining the ballot number based on the first and second location values comprises summing the first and second location values.

25. The method of claim 21, wherein the first voter share value and the second voter share value received from each of the first and second ballot collection servers are random or pseudo-random values.

26. The method of claim 21, further comprising receiving, by the voter computing device, the selected choice of a user from a user input of the voter computing device.
